(19) United States
(12) Patent Application Publication
(10) Pub. No.: US 2026/0112244 A1
(43) Pub. Date: Apr. 23, 2026

(54) SYSTEMS AND METHODS FOR ASSIGNING WEIGHTS TO INTERACTION TYPES IN A DISTRIBUTED NETWORKING ENVIRONMENT USING LANGUAGE MODELS

(71) Applicant: DK Crown Holdings Inc., Boston, MA (US)

(72) Inventors: Robin Mohseni, Billericay (GB); Gengyuan Zhang, Boston, MA (US)

(73) Assignee: DK Crown Holdings Inc., Boston, MA (US)

(21) Appl. No.: 19/360,886

(22) Filed: Oct. 16, 2025

Related U.S. Application Data
(60) Provisional application No. 63/708,554, filed on Oct. 17, 2024.
(60) Provisional application No. 63/708,492, filed on Oct. 17, 2024.
(60) Provisional application No. 63/708,542, filed on Oct. 17, 2024.
(60) Provisional application No. 63/708,509, filed on Oct. 17, 2024.
(60) Provisional application No. 63/708,528, filed on Oct. 17, 2024.
(60) Provisional application No. 63/708,504, filed on Oct. 17, 2024.
(60) Provisional application No. 63/711,415, filed on Oct. 24, 2024.
(60) Provisional application No. 63/719,406, filed on Nov. 12, 2024.
(60) Provisional application No. 63/741,297, filed on Jan. 2, 2025.
(60) Provisional application No. 63/741,671, filed on Jan. 3, 2025.

(51) Int. Cl. G07F 17/32; G06F 40/35; G06F 40/40; G06Q 50/34

(52) U.S. Cl. CPC G07F 17/323; G06F 40/40; G06Q 50/34; G07F 17/3237; G07F 17/3288; G06F 40/35

(57) ABSTRACT

Described herein are systems and methods for providing wager recommendations and wager comparisons based on a player prompt by preparing the input context of a large language model. A system can maintain an indexed data structure comprising a plurality of wager scenarios corresponding to a plurality of live events, wherein each wager scenario is associated with a respective odds value. The system can receive, from a client device, a prompt comprising an indication of a game parameter tolerance. The system can select a subset of the wager scenarios based on the game parameter tolerance indicated in the prompt and the respective odds values retrieved via indexes of the indexed data structure. Using a language model, the system can generate an output message identifying at least one of the selected wager scenarios to satisfy the game parameter tolerance. The system can provide the output message to the client device in response to the prompt.

### CROSS-REFERENCES TO RELATED APPLICATIONS

This application claims the benefit of and priority to U.S. Provisional Patent Application No. 63/741,297, filed Jan. 2, 2025; and claims the benefit of and priority to U.S. Provisional Patent Application No. 63/708,509, filed Oct. 17, 2024; and claims the benefit of and priority to U.S. Provisional Patent Application No. 63/708,492, filed Oct. 17, 2024; and claims the benefit of and priority to U.S. Provisional Patent Application No. 63/708,528, filed Oct. 17, 2024; and claims the benefit of and priority to U.S. Provisional Patent Application No. 63/708,542, filed Oct. 17, 2024; and claims the benefit of and priority to U.S. Provisional Patent Application No. 63/708,504, filed Oct. 17, 2024; and claims the benefit of and priority to U.S. Provisional Patent Application No. 63/711,415 , filed Oct. 24, 2024; and claims the benefit of and priority to U.S. Provisional Patent Application No. 63/708,554, filed Oct. 17, 2024; and claims the benefit of and priority to U.S. Provisional Patent Application No. 63/719,406, filed Nov. 12, 2024; and claims the benefit of and priority to U.S. Provisional Patent Application No. 63/741,671, filed Jan. 3, 2025; the contents of each of which are incorporated herein by reference in their entireties for all purposes.

### BACKGROUND

Network environments can support communication between multiple computing devices using techniques such as packet-switching. Data transmitted between devices can be synchronized such that multiple devices on the same network access the same information. However, it can be challenging to efficiently synchronize data transmission using conventional networking technology.

### SUMMARY

At least one aspect of the present disclosure is directed to a system. The system can include one or more processors coupled to memory. The one or more processors may maintain a data structure that includes a plurality of wager opportunities corresponding to a plurality of live events. In some embodiments, each of the plurality of wager opportunities corresponds to a wager type of a plurality of wager types. The one or more processors may receive a prompt that includes a request for a wager type recommendation to be interpreted by a language model from a client device associated with a player profile. The one or more processors may determine a classification of the request included in the prompt. The one or more processors may generate an input context for the language model using the prompt and the classification. The one or more processors may generate, using the language model and the plurality of wager opportunities, an output that identifies or otherwise indicates a subset of the plurality of wager opportunities, where the subset of the plurality of wager opportunities has a subset of wager types. The one or more processors may provide the output to the client device in response to the request.

In some embodiments, the one or more processors may maintain a data structure that includes a plurality of wager opportunities corresponding to a plurality of live events. In some embodiments, each of the plurality of wager opportunities is associated with a respective odds value. In some embodiments, the one or more processors may receive, from a client device, a prompt comprising an indication of a risk tolerance. The one or more processors may determine an indication of the risk tolerance based on the prompt and select a subset of the plurality of wager opportunities based on the indication of the risk tolerance and the respective odds value of the plurality of wager opportunities. The one or more processors may generate an output message identifying at least one of the subsets of the plurality of wager opportunities to satisfy the risk tolerance of the prompt using a language model, the subset, and the prompt. The one or more processors may then provide the output message to the client device in response to the prompt.

In some embodiments, the one or more processors may maintain a data structure that includes a plurality of wager opportunities corresponding to a plurality of live events. In some embodiments, each of the plurality of wager opportunities is associated with a respective odds value. In some embodiments, the one or more processors may receive a prompt from a client device during a communication session identifying a first wager opportunity of the plurality of wager opportunities. The prompt may include or otherwise indicate a request for a comparison to the first wager opportunity. The one or more processors may then generate an input context for a language model using the prompt, data of the first wager opportunity, and at least one second wager opportunity selected from the plurality of wager opportunities. The one or more processors may then generate, using the language model and the input context, an output message indicating the comparison between the first wager opportunity and the at least one second wager opportunity. The one or more processors may then provide the output message to the client device in response to the prompt.

These and other aspects and embodiments are discussed in detail below. The foregoing information and the following detailed description include illustrative examples of various aspects and embodiments and provide an overview or framework for understanding the nature and character of the claimed aspects and embodiments. The drawings provide illustration and a further understanding of the various aspects and embodiments and are incorporated in and constitute a part of this specification. Aspects may be combined, and it will be readily appreciated that features described in the context of one aspect of the invention may be combined with other aspects. Aspects may be implemented in any convenient form. For example, by appropriate computer programs, which may be carried on appropriate carrier media (e.g., computer readable media), which may be tangible carrier media (e.g., disks) or intangible carrier media (e.g., communications signals). Aspects may also be implemented using suitable apparatuses, which may take the form of programmable computers running computer programs arranged to implement the aspect. As used in the specification and in the claims, the singular forms of “a,” “an,” and “the” include plural referents unless the context clearly dictates otherwise.

### BRIEF DESCRIPTION OF THE DRAWINGS

The foregoing and other objects, aspects, features, and advantages of the disclosure will become more apparent and better understood by referring to the following description taken in conjunction with the accompanying drawings.

FIG. 1 illustrates a block diagram of an example system for using, in response to a player-generated prompt, a language model to generate, filter, and compare wager opportunities associated with live events, in accordance with one or more embodiments.

FIG. 2 illustrates an example flow diagram of a method for generating wager opportunity recommendations associated with live events based on a player-generated prompt, in accordance with one or more embodiments.

FIG. 3 illustrates an example flow diagram of a method for filtering wager opportunities associated with live events based on a player-generated prompt, in accordance with one or more embodiments.

FIG. 4 illustrates an example flow diagram of a method for performing a game scenario comparison associated with live events based on a player-generated prompt, in accordance with one or more embodiments.

FIG. 5 illustrates an example implementation of an application interface to retrieve wager scenario recommendations and to limit wager scenario searches based on a game parameter tolerance in accordance with one or more implementations.

FIG. 6 illustrates an example implementation of an application interface to retrieve wager scenario comparisons in accordance with one or more implementations.

FIG. 7 illustrates a block diagram of a server system and a client computing system in accordance with an illustrative implementation.

### DETAILED DESCRIPTION

Below are detailed descriptions of various concepts related to, and embodiments of, techniques, approaches, methods, apparatuses, and systems for providing interactive game experiences. The various concepts introduced above and discussed in greater detail below may be implemented in any of numerous ways, as the described concepts are not limited to any particular manner of implementation. Examples of specific embodiments and applications are provided primarily for illustrative purposes.

Natural language processing techniques can be applied across a wide range of computing environments to generate responses or other outputs based on natural language prompts. Language models and other machine-learning models can be used in various applications, including but not limited real-time information retrieval interfaces, which can be limited according to processing capacity of the systems executing such machine-learning models. To perform such operations, a language model can process input data sequences that represent prompts, contextual information, and other relevant data.

As language models typically include a large number of parameters, invoking such language models typically requires significant processing resources that make language models challenging to use for certain applications (e.g., real-time or near real-time applications. The number of operations and the amount of memory used to process a prompt is generally influenced by the size of the input context provided to the language model. Input contexts can include historical exchanges, metadata, and/or external reference information that may be relevant to generating an accurate or contextually suitable output. Generating suitable outputs typically involves providing large amounts of information as input to language models, which can significantly hinder performance, both in terms of accuracy and execution performance (e.g., computing resource utilization).

Conventional techniques for supplying input contexts to language models fail to ameliorate these issues. For example, conventional approaches often require sending large contexts, which often include an entire accumulated input, across multiple requests to achieve a requested output. Increasing the size of the input context results in increased network latency and bandwidth consumption. During output generation, executing language models with large input contexts causes processor load and increased memory allocation that grow at rates that reduce the feasibility of using language model in many real-time or near real-time applications. As a result, existing systems experience limited throughput, excessive memory consumption, and elevated network resource usage.

The techniques described herein address these and other issues by generating targeted input contexts for a language model that include only data determined to be relevant to a given prompt. In general, the techniques can select prompt-specific subsets of available context data based on one or more classification processes and/or rule-based policies. By constructing an input context from only the selected subset, the techniques described herein can significantly reduce the processing resources needed to process the input context without omitting information that is pertinent to generating an accurate output. Such context selection operations can be perform in connection with session-based data persistence, such that follow-on prompts can be processed according to previously stored interaction data, in some implementations.

By selectively reducing the contents of an input context based on prompt relevance and by avoiding redundant transmission of static context data, the techniques described herein can lower processing time and memory requirements for language model execution. Network bandwidth consumption can also be reduced because only incremental or newly relevant data is transmitted for follow-on prompts, rather than the entire accumulated context. These improvements can provide faster response times for multi-turn interactions, sustain throughput in high-load scenarios, and enable the use of large-scale language models within low-latency applications where conventional approaches would exceed performance constraints.

In further detail, various implementations of the systems and methods described herein can be used to reduce processor utilization and memory consumption when processing prompts with additional contextual input via one or more language models or other machine-learning models. For example, a system can maintain one or more data structures storing specific information that can be automatically selected for inclusion in an input context of the language/machine-learning models. As noted above, the computing resources (e.g., computing time and/or memory/caching consumption) used to execute language models or other natural language processing functions on computers increase at least quadratically with the size of the input context (e.g., the input data to be processed). Executing language models using existing techniques therefore restricts the context size according to the expected/target processing time of a corresponding request. For real-time or near real-time applications, such extended delays make using language models impossible to use.

To address these challenges, the systems and methods described herein can dynamically generate an input context that includes a subset of data that can be used to carry out requested computing operations. Such automatic selection may be performed, for example, according to intent classification operations executed using additional machine-learning models and/or specific rules-based selection policies. By automatically selecting certain data to be included in the input context, the systems and methods described herein automatically limit the input context for the language model to a targeted subset of available data, thereby reducing the latency (e.g., processing time) and memory allocation required to carry out the requested operations using the language model. As a result, the systems and methods described herein operate more efficiently, and allow for the use of language models in real-time or near real-time processing applications, which would otherwise be impossible to implement using existing techniques.

For purposes of reading the descriptions of the various embodiments below, the following descriptions of the sections of the Specification and their respective contents may be helpful:
I. Section A describes a remote or local computing environment that may be useful for providing language model system functionalities.
II. Section B describes systems and methods for generating wager opportunity recommendations for different types of wagers.
III. Section C describes systems and methods for filtering wager opportunities associated with live events based on game parameter tolerances.
IV. Section D describes systems and methods for performing a game scenario comparison associated with live events based on a player-generated prompt.
V. Section E describes a set of application interfaces.
VI. Section F describes a computing and networking environment that may be useful for practicing the embodiments described herein.

### A. Remote or Local Computing Environment for Providing Shared-Domain Generative Language Models

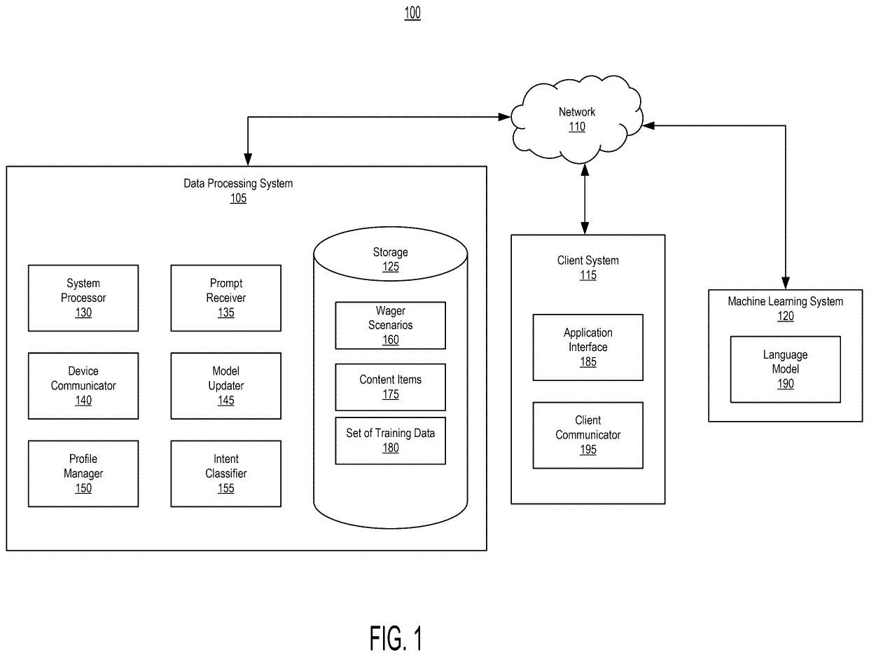

FIG. 1 depicts a system for using, in response to a player-generated prompt, a set of language models to generate, filter, and compare wager opportunities associated with live events, in accordance with one or more embodiments. In FIG. 1, the system 100 can include at least one data processing system (e.g., a data processing system 105), at least one network (e.g., a network 110), at least one client system (e.g., client system 115), and at least one machine learning system (e.g., a machine learning system 120). In FIG. 1, the data processing system 105 can include one or more storage (e.g., a storage 125), one or more system processors (e.g., a system processor 130), one or more prompt receiver subsystems (e.g., a prompt receiver subsystem 135), at least one device communicator (e.g., a device communicator subsystem 140), at least one model updater subsystem (e.g., a model updater subsystem 145), at least one profile manager subsystem (e.g., a profile manager subsystem 150), and at least one intent classifier subsystem (e.g., an intent classifier subsystem 155). The storage 125 can include a set of wager scenarios 160, a set of content items 175, and set of training data 180. The client system 115 can execute an application that communicates with the data processing system 105, can include at least one application interface (e.g., the application interface 185), and can include at least one client communicator (e.g., a client communicator 195). The machine learning system 120 can include a set of language models 190.

The data processing system 105 can include a physical computer system operatively coupled or couplable with one or more components of the system 100. Furthermore, the data processing system 105 can connect with the client system 115. The client system 115 can include a computing system that may be used to access the functionality of the data processing system 105. The client system 115 can include a smart phone, mobile device, laptop computer, desktop computer, one or more servers, or any other type of computing device. The client system 115 can include at least one processor and a memory, e.g., a processing circuit.

The machine learning system 120 can include one or more machine learning models trained on various datasets, including but not limited to datasets for a large language model (LLM), such as one or more language models of the set of language models 190. In some embodiments, the data processing system 105 of the system 100 can establish a communication session via the network 110, for example, with the client system 115 or the machine learning system 120. Establishing a communication session can refer to creating a temporary connection between two or more devices to exchange information. For example, this can include setting up a data exchange session between the client system 115 and the data processing system 105.

The data processing system 105, the client system 115, or the machine learning system 120 can store in the storage 125 the results of any or all computations, determinations, selections, identifications, generations, constructions, or calculations in one or more data structures indexed or identified with appropriate values. Any or all values stored in the storage 125 may be accessed by any computing device described herein, such as the data processing system 105, the client system 115, or the machine learning system 120, to perform any of the functionalities or functions described herein. In some embodiments where the storage 125 forms a part of a cloud computing system, the storage 125 may be a distributed storage medium in a cloud computing system and may be accessed by any of the components of the data processing system 105, the client system 115, the machine learning system 120, or any other computing devices described herein.

The storage 125 can store the set of content items 175, which may include any digital content that can include different content formats, including media and interactive modules. In some embodiments, the one or more models of the set of language models 190 can generate a data structure that includes instructions for generating the set of content items 175. The client system 115 can parse the data structure to generate portions of the text or relevant elements. In some embodiments, the data structure can correspond to text content associated with a wager, which can include references to specific entities or actions within the application interface 185.

The storage 125 can store the set of wager scenarios 160 (sometimes referred to herein as “wager opportunities 160”) for one or more live events. The set of wager scenarios 160 can include event information, identifying the specific live event each wager is tied to, such as team names, game details, etc. The set of wager scenarios 160 can include bet options, including different types of bets available for each event, such as moneyline, point spread, or over/under, among other markets. The set of wager scenarios 160 can include odds, for example, the payout ratio associated with each wager and how much a winning wager would return. The set of wager scenarios 160 can include an indication of a live event. The live event can function as an identifier or reference, pointing to a specific ongoing live event from the available selections. The set of wager scenarios 160 can include an indication of a parlay or a single bet recommendation. For example, the set of wager scenarios 160 can include flags or markers indicating whether a wager is a parlay or a single bet. The set of wager scenarios 160 can include a record of the number of wagers placed. The set of wager scenarios 160 can include data corresponding to historical wager opportunities (e.g., past wagers) used to calculate or adjust the odds associated with the current wager opportunities.

In some embodiments, odds associated with the set of wager scenarios 160 may be dynamically adjusted based on various factors, such as live event data/developments, fluctuations in betting volume, and historical wager patterns, among others. In some embodiments, upon detecting significant events, such as scores or timeouts, the data processing system 105 can recalculate and adjust wager odds. In some embodiments, the data processing system 105 can track the popularity of specific wager types or specific wager opportunities, such as a straight bet wager, same-game parlay (SGP) wager, a quick SGP, exotic wager, etc. The data processing system 105 may track the number of times the corresponding wager types/opportunities have been selected. For example, each wager opportunity of the set of wager scenarios 160 can include or be associated with a counter that is incremented each time the wager opportunity is placed by a player via the data processing system 105. In some embodiments, and as described in further detail herein, the counter may be displayed as part of the set of content items 175 corresponding to one or more wager scenarios of the set of wager scenarios 160. Furthermore, based on prompts and betting trends, the data processing system 105 can categorize or flag the set of wager scenarios 160 as components or legs of parlay wagers.

The storage 125 can store set of training data 180. The set of training data 180 can include a collection of structured data used to train one or more models of the set of language models 190 (or other machine learning models described herein) to perform specific tasks. The data processing system 105 can collect data from sources such as sports data providers, betting platforms, player interactions, and more, through data extraction, data retrieval, or similar techniques. The data processing system 105 can address missing values, inconsistencies, and outliers to maintain data quality, for example, through data cleaning or preprocessing. The data processing system 105 can aggregate data from multiple sources to generate a set of training data 180. In some embodiments, the data processing system 105 can generate additional data for the set of training data 180.

In some embodiments, the data processing system 105 can additional data for the set of training data 180 for one or more models of the set of language models 190. For example, the set of training data 180 can include function calling datasets. The function calling datasets can include prompt-response pairs, where the response can include calling a specific function. In some embodiments, the set of training data 180 can include various datasets used for prompt engineering, which can provide structured prompts across different themes and scenarios. In some embodiments, the set of training data 180 can include conversational datasets, which may be used for training and evaluating one or more models of the set of language models 190. The conversational datasets can include collections of comments structured in threaded conversations, such that one or more models of the set of language models 190 can generate data structures corresponding to human-like text based on the input context. In some embodiments, the data processing system 105 can generate artificial data to supplement the set of training data 180, for example, when dealing with limited data availability, through synthetic data generation. In some embodiments, the data processing system 105 can assign labels or tags to data points for supervised learning tasks through labeling and annotation. In some embodiments, the data processing system 105 can generate additional features or transform existing ones to improve model performance through feature engineering.

The set of training data 180 can function as a knowledge base from which the machine learning models learn patterns and relationships. The set of training data 180 can include various data formats, including text, numerical data, and structured data related to sports events, teams, player statistics, and betting odds, among others. The set of training data 180 may include individual data points, referred to as training examples. Each training example can include an input and a corresponding output. The set of training data 180 may be labeled (where the outcome is known) or unlabeled (where the outcome is not known), depending on the type of learning, such as supervised or unsupervised learning. In supervised learning, the set of training data 180 can include labeled examples where the input can include a specific sporting event (e.g., a basketball game between Team A and Team B), bet type (e.g., moneyline), and the current odds. The output may be the correct outcome of the wager, for instance, whether Team A/Team B wins or loses. The unsupervised learning techniques may be applied to identify hidden patterns within the unlabeled data of the set of training data 180, such as frequently occurring betting combinations or identifying customer segments based on betting behavior. Once the set of training data 180 is generated, the machine learning model can undergo an iterative learning process. For example, the model may be presented with prompts related to sports events and wagers, and the model can generate predictions or classifications. These predictions may be compared to the known outcomes, and the model's parameters may be adjusted accordingly.

In some embodiments, the set of training data 180, the set of wager scenarios 160, or other data used in this disclosure may be collected and stored in structured data formats. These datasets, along with predefined formatting instructions for different wager types, may be used to generate training examples. Each training example can include a wager opportunity of the set of wager scenarios 160 or deep link as input and the desired output format as output. In this manner, a machine learning model can learn to generate the desired content and layouts. In some embodiments, the model updater subsystem 145 can generate prompts to simulate player requests for wager recommendations. These prompts, combined with relevant wager data, may be used to create additional training examples. The machine learning model can learn to generate customized wager recommendations based on player preferences and available options. In some implementations, the prompts may include requests for wagers having a target risk or reward (e.g., in terms of dollar amount, etc.) or target odds, as described in further detail herein.

The data processing system 105 includes the prompt receiver subsystem 135, which may parse and process the prompts to extract information, such as wager type, amount, and game selections, among others. The prompt receiver subsystem 135 can execute functions based on the prompt's content. In some embodiments, the prompt receiver subsystem 135 can perform validation checks. For example, the prompt receiver subsystem 135 can validate the requested wager against current betting odds or predefined rules. The prompt receiver subsystem 135 can validate the sufficiency of the player's account balance via the profile manager subsystem 150. The prompt receiver subsystem 135 can validate the timing of the bet. The prompt receiver subsystem 135 can facilitate the transmission of the wager to the service provider's backend, where the wager is logged and acted upon. The prompt receiver subsystem 135 can format the wager information or the player's input into a standardized data structure for transmission to the backend for further processing, such as logging, risk assessment, and odds calculation, among others. The prompt receiver subsystem 135 can collect or store records of player-provided prompts (and in some embodiments, conversation records including corresponding responses) in the storage 125 as part of set of training data 180 to improve the classification accuracy of one or more models of the set of language models 190 over time, in some embodiments.

The data processing system 105 includes the device communicator subsystem 140. The device communicator subsystem 140 may be compatible with diverse items of the set of content items 175 and may be compatible with particular content delivery systems corresponding to particular items of the set of content items 175, structures of data, types of data, or any combination thereof. For example, the device communicator subsystem 140 may be compatible with the transmission of text data or binary data structured according to one or more metrics or data of the application interface 185 or the client system 115. The device communicator subsystem 140 can provide the client system 115 with instructions to display lists of interactive options, such as live events, content items, or wagering opportunities.

The model updater subsystem 145 can update the machine learning models based on data available to the system processor 130, such as one or more models of the set of language models 190, using a dataset that includes numerous training examples. Each training example can include an input context and a corresponding output message. The input context can include data related to wager opportunities, deep links, player behavior, or any other relevant information. The output message can define the response or outcome, such as text messages, recommendations, or instructions for displaying information. The configuration and training of a language model of the set of language models 190 can include various training parameters, such as the learning rate, number of epochs, batch size, activation functions, and regularization techniques, to improve learning and prevent overfitting. The model updater subsystem 145 can leverage feedback mechanisms and adaptive learning strategies such that the set of language models 190 is aligned with evolving language patterns relating to the set of wager scenarios 160, or live events (or information associated therewith).

The data processing system 105 can include the profile manager subsystem 150. The player profiles may be associated with a user (sometimes referred to herein as a “player”) of the client system 115 associated with a client device. The player profile of a player may be or include a record profile that stores information about the player or information about the client system 115 (or another client system) used to access the data processing system 105 using the player profile. For example, the identifiers of the player profile may be used to access the functionality of the data processing system 105. The identifiers can include a username, a password, an e-mail address, a phone number, a personal identification number (PIN), a secret code-word, and device identifiers for use in a two-factor authentication technique, among others. The player profile can store information about wagers, games, and live events that are performed by the player via the data processing system 105. The player profile can store a credit balance, wager information, or side wager information (e.g., an amount of a wager/side wager, a timestamp associated with a wager/side wager, information about gaming conditions or game state information that resulted in a side wager, a client device identifier of the client system 115 that was used to place the wager/side wager, etc.). The player profile can store information about the client system 115 used to access the data processing system 105, such as an IP address, a MAC address, a GUID, a player profile name (e.g., the name of a user of the client system 115, etc.), and a device name, among others. In some embodiments, the player profile may be created by the data processing system 105 in response to the player profile creation request transmitted by the client system 115.

The profile manager subsystem 150 may be or include any script, file, program, application, set of instructions, or computer-executable code that is configured to create, modify, delete, or otherwise manage player profiles stored within the profile manager subsystem 150 or within the storage 125. The data processing system 105 may use the profile manager subsystem 150 to retrieve one or more player profiles from a player profile database, which may be or include the storage 125.

The profile manager subsystem 150 can store and organize player information, including account details, preferences, and gaming history, among others. The profile manager subsystem 150 can generate profile information based on data received from the client system 115. This configuration can allow the profile manager subsystem 150 to capture activity across different interactive applications and different devices, and store records of that activity in the player profile. The profile manager subsystem 150 can update credit balances, game statistics, and other relevant information based on the outcomes of games played by the client system 115. The profile manager subsystem 150 can receive data about game results from the client system 115 and use this information to make adjustments to the player profile. The profile manager subsystem 150 can store game statistics such as the number of wins, losses, and ties, as well as the player's average bet size, win percentage, and longest winning streak, among others. In some embodiments, the profile manager subsystem 150 can store records of player interactions, including prompts, responses, or conversation histories, with one or more models of the set of language models 190.

The data processing system 105 can include the intent classifier subsystem 155. The intent classifier subsystem 155 can parse prompts received from the client system 115 to determine an intent of the prompts. For a given prompt, the data processing system 105 can use the intent classifier subsystem 155 to generate an input context for one or more models of the set of language models 190 using the prompt and its classification. The input context can include a variety of information, such as prompts, questions, or previous parts of a conversation. The intent classifier subsystem 155 can identify the desired action or information sought by the player.

In some embodiments, the intent classifier subsystem 155 can use rule-based techniques to identify player intents. For example, the intent classifier subsystem 155 can use a set of predefined rules or patterns that match specific prompts to predefined intents. In some embodiments, the intent classifier subsystem 155 can use keyword matching or regular expressions to identify patterns that capture variations in prompts. For example, a rule can specify that a prompt related to placing a wager may indicate a betting intent. In some embodiments, the intent classifier subsystem 155 can use machine learning models to identify a wider range of intents, including those that are context-dependent or ambiguous. For example, the intent classifier subsystem 155 can use implement vector machines (SVMs), naive bayes, or deep learning architectures such as recurrent neural networks (RNNs) and transformers (BERT). The models may be trained on large datasets of player-provided prompts and their corresponding intents. The intent classifier subsystem 155 can use the machine learning model(s) to distinguish between player intents, such as checking odds, placing wagers, or requesting payouts, among other prompts.

The intent classifier subsystem 155 can process player-provided prompts to extract the underlying intent or purpose. The intent classifier subsystem 155 can categorize the player's prompt into specific intents, such as placing a bet, checking odds, or requesting information about a specific game or team. The intent classifier subsystem 155 can determine the actions to fulfill the player's request based on the classified intent. For example, if a player enters the prompt “Odds for Team A to win tonight?”, the intent classifier subsystem 155 can determine that the prompt is a request for wagering information, identify the specific wager type as a moneyline bet, and extract relevant details such as the team's name (in this example, Team A) and the game timeframe (in this example, tonight).

In some embodiments, upon receiving a prompt (e.g., a first prompt), the intent classifier subsystem 155 can process the input to identify the player's intent or an intended application interface (e.g., the application interface 185), for example, by processing keywords, entities, or semantic meaning. In some embodiments, where the intent classifier subsystem 155 cannot identify the application interface 185 based on the first prompt, the intent classifier subsystem 155 can provide an indication to the client system 115 that additional information is desired. The client system 115 can transmit a second prompt to the data processing system 105. The intent classifier subsystem 155 can process the first and second prompts to identify the application interface 185 as an intended interface or a set of player intents based on data provided via the application interface 185. For example, if the first prompt reads “Odds for” and the second prompt reads “Team A baseball game tonight,” the intent classifier subsystem 155 can determine that the player intends to access the current odds for tonight's baseball game for Team A. In some embodiments, a plurality of prompts (e.g., the first prompt and the second prompt) may be received in response to interactions by a player with the client system 115.

In some embodiments, based on the prompt or system-defined criteria, the intent classifier subsystem 155 can retrieve additional relevant wagers from the storage 125. In some embodiments, the intent classifier subsystem 155 can retrieve additional wagers to combine with an existing wager, forming a parlay bet. For example, the intent classifier subsystem 155 can identify potential legs for the parlay based on available betting options. In some embodiments, the intent classifier subsystem 155 or the prompt receiver subsystem 135, depending on the implementation, can process player requests for payout information. For example, upon receiving a prompt about wager winnings, the intent classifier subsystem 155, via the data processing system 105, can cause one or more models of the set of language models 190 to generate a data structure that includes the details of the payout based on the wager's outcome and odds. In some embodiments, where the intent classifier subsystem 155 receives updates (e.g., updated odds for a specific wager), the intent classifier subsystem 155 can search through the existing wager data in the storage 125 to find the corresponding wager based on identifiers (e.g., wager ID).

The application interface 185 can include graphical user interfaces or graphical elements that present content items, interaction modes, or wager recommendations. The application interface 185 can dynamically configure the graphical user interface based on a player's activities and preferences. The application interface 185 can receive interactions from the player, such as selections or specifications of wagers to be placed through the application interface 185. In response to receiving the interactions, the client application presenting the application interface 185 can communicate with the data processing system 105 to execute the placement of wagers. In some embodiments, the application interface 185, via the client system 115, can cause the data processing system 105 to update the storage 125 to include the details of the wager counts. In some embodiments, upon interaction with a graphical element, the application interface 185, via the data processing system 105, can cause the profile manager subsystem 150 to update a player profile associated with the client system 115 according to the wager placed.

The machine learning system 120 can include one or more models of the set of language models 190. In some embodiments, one or more models of the set of language models 190 can generate a data structure, including details or instructions for generating a graphical element that displays wager recommendations or other relevant information. In another example, one or more models of the set of language models 190 can generate a data structure having instructions to present statistics or details relating to one or more live events. Such data structures can include details such as chart type, data points (e.g., team names, odds), axes labels (e.g., teams, scores, etc.), and formatting details (colors, fonts, sizes), which may be used to visualize real-time data or near real-time data from live events. In some embodiments, where a player interacts with a graphical element of a user interface (e.g., the application interface 185) representing a wager recommendation, the data processing system 105 can update the associated player profile accordingly.

In some embodiments, one or more models of the set of language models 190 can generate data structures corresponding to the textual content associated with a wager, such as descriptions, explanations, or promotional materials. The textual content may be incorporated into one or more larger items of the set of content items 175 or displayed independently. In some embodiments, one or more models of the set of language models 190 can include additional wagers in the data structure. A model of the set of language models 190 can receive the additional wagers via the input context. The data structure can include details regarding the wager type (e.g., moneyline, point spread, parlay) and relevant details, such as teams, odds, and bet amounts. In some embodiments, one or more models of the set of language models 190 can generate an additional data structure or update an existing data structure in response to receiving an input context that includes updated information, such as new odds for a specific wager. The data structure can include a timestamp indicating when the update occurred and a list of changes. For example, each change can specify the field that was modified. A model of the set of language models 190 can transmit the updated data structure, including the updated wager data, to the client system 115 via the data processing system 105.

In some embodiments, where the client system 115 is associated with a player profile, the data structure generated by one or more models of the set of language models 190 can include instructions to generate an interactive element that, when interacted with, can cause the client system 115 to transmit a request to the profile manager subsystem 150 to update the player profile based on, for example, wager recommendations. In some embodiments, one or more models of the set of language models 190 can process input contexts for payout information. For example, upon receiving an input context about wager winnings, one or more models of the set of language models 190 can generate a data structure, including the details of the potential payout based on the wager's outcome and odds. The client system 115 can parse the data structure and present the information along with any relevant details via the application interface 185.

In some embodiments, one or more models of the set of language models 190 can generate instructions for content items that present wager opportunities. The content items can include candidate prompts or interactive elements. For example, the content item can indicate adding a specific team to an existing parlay wager. Based on player preferences and the current content items, the data processing system 105 can generate input contexts for one or more models of the set of language models 190 to incorporate wagers into the text data of the set of content items 175. Player interactions with the set of content items 175, such as taps, clicks, or hovers, may be captured by the client system 115 and transmitted, via the client system 115, to the data processing system 105. The data processing system 105 can process the interaction to generate additional input contexts for one or more models of the set of language models 190. For example, upon receiving the input context, one or more models of the set of language models 190 can generate a data structure corresponding to the additional content items. In some embodiments, one or more models of the set of language models 190 can generate data structures corresponding to dynamic the set of content items 175, including descriptive text to accompany images.

In some embodiments, the data processing system 105 can directly execute one or more models of the set of language models 190 as a component. The data processing system 105 can select one or more models of the set of language models 190 based on factors, such as computational complexity, efficiency, and task-specific capabilities, among other attributes. The data processing system 105 can use data cleansing, tokenization, or other standardization techniques to maintain compatibility with the a model of the set of language models 190. In some embodiments, the data processing system 105 can implement batch processing, data streaming, or asynchronous data management techniques to manage data flow into one or more models of the set of language models 190. In some embodiments, where the data processing system 105 is using an API to access the functionality of one or more models of the set of language models 190, the data processing system 105 can integrate API calls into its operational workflow. In some embodiments, where the data processing system 105 is deploying one or more models of the set of language models 190 on local infrastructure, the data processing system 105 can load one or more models of the set of language models 190 into system memory. The data processing system 105 can format incoming data to match the input structure of one or more models of the set of language models 190.

### B. Systems and Methods for Generating Wager Opportunity Recommendations for Different Types of Wagers

Unless stated otherwise, operations of the flow diagrams in this disclosure or other operations described in this disclosure may be executed, performed, or otherwise carried out by an interactive server or a system. For example, a method 200 may be executed, performed, or otherwise carried out by an interactive server or a system. A data processing system (e.g., the data processing system 105) may be remote to one or more client systems (e.g., the client system 115) and one or more machine learning systems (e.g., the machine learning system 120) and can communicate with the one or more client systems or the one or more machine learning systems via a computer network (e.g., the network 110).

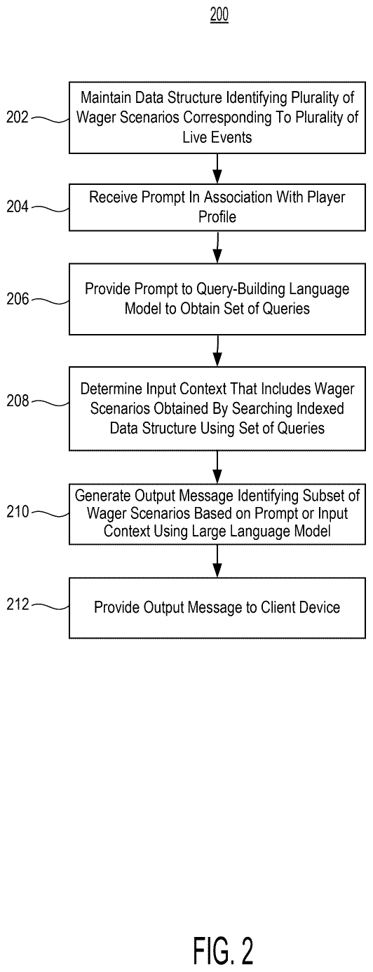

FIG. 2 illustrates an example flow diagram of a method for generating wager opportunity recommendations associated with live events based on a player-generated prompt, in accordance with one or more embodiments. The method 200 may be executed, performed, or otherwise carried out by an interactive server or a system. A data processing system (e.g., the data processing system 105) may be remote to one or more client systems (e.g., the client system 115) and one or more machine learning systems (e.g., the machine learning system 120) and can communicate with the one or more client systems or the one or more machine learning systems via a computer network (e.g., the network 110). In a brief overview of method 200, the interactive server or the system can maintain a plurality of wager opportunities corresponding to a plurality of live events (BLOCK 202), receive a prompt in association with a player profile (BLOCK 204), provide a prompt to a query-building language model to obtain a set of queries (BLOCK 206), determine an input context that includes wager scenarios obtained by searching an indexed data structure using the set of queries (BLOCK 208), generate an output message identifying a subset of wager scenarios based on the input context or the prompt using a large language model (BLOCK 210), or provide the output message to a client device (BLOCK 212).

Some embodiments may maintain a data structure identifying a plurality of wager scenarios corresponding to a plurality of live events, as indicated by BLOCK 202. A data processing system can maintain a storage of historical wager scenarios and associated data (e.g., related scenarios, number of players who selected the wager, formatting instructions, etc.). The storage, structured as a database or a collection of data structures, may be used for system operations. A data structure used to store wager scenarios and related data may be indexed, such that an indexed data structure may include one or more various types of data stores that are indexed. For example, an indexed data structure may include one or more various types of data stores that are indexed using one or more indexing methods, such as B−Tree and B+Tree indexing, hash indexes, bitmap indexes, R−Tree indexes, clustered indexes, etc. Some embodiments may maintain multiple indexes that permit and induce a search to pursue both the target items indicated by a player and also search for alternative records that are not explicitly defined by the player. The multiple indexes may further include other associations between wagers not apparent to a player, such as alternative bet associations between a record for a wager involving a first outcome for a sports team and a wager involving a team member in the sports teams performing a specified task. The specified task may include scoring a number of points, committing a number of sports actions, etc. Some embodiments may update the indexes without updating the events themselves based on an indicated popularity for an alternative bet.

In some embodiments, historical wager scenarios can refer to a record of past wager opportunities or wager options that have been available on a betting platform. In some embodiments, the historical wager scenarios may include simulated wager scenarios used to present to a player such that a player may indicate a perceived likelihood of the simulated wager scenario occurring. For example, a wager scenario may indicate a hypothetical wager opportunity such that a player may indicate a likelihood of the hypothetical wager opportunity being presented in the next day. The historical wager scenarios can include a range of information including event details (e.g., which can specify the particular sporting event, match, or competition associated with the scenario), bet types (e.g., which can indicate different wagering options available for the event such as moneyline, point spread, parlay, etc.) odds (e.g., a probability score or values which can indicate the payout ratios for each wager option at different points in time), wager outcomes (e.g., which can indicate the final results of the event and the corresponding win/loss status for each wager type), and other relevant data (e.g., which can include additional information such as wager limits, wager popularity, or associated promotional activities), among others.

In some embodiments, a data processing system can maintain wager scenario records in storage that include wager type information. For example, the data processing system may indicate a wager opportunity or other type of wager scenario with a structured record, including fields such as an identifier, event details (sport, teams, date, time), wager type (moneyline, point spread, same-game parlay, multi-game parlay, exotic wager, etc.), odds, wager limits, and other relevant attributes (e.g., player prop, team prop), among others. In such a data structure, each respective opportunity of a set of wager opportunities may be associated with a respective wager type indicating the general type of wager for that respective opportunity.

In some embodiments, a data processing system may initialize a container application in a container and then generate, with the container application, a set of vector stores to index wager scenarios by line values, alternate line values, or other wager-relevant relationships. For example, some embodiments may use the container application to generate a first vector store to index wager opportunities by matching line values and a second vector store to index wager opportunities by alternate line values. Some embodiments may then persist these generated data stores in a persistent storage resource such that, even after the container itself is closed, the persistent storage resource will continue to store the generated vector stores. For example, some embodiments may use an artificial intelligence framework to access/retrieve/load documents, articles, data tables, or other sources of text data related to wagers into a data store and extract the data into vector representations. Some embodiments may then use an indexing system, such as a system based on a Facebook Artificial Intelligence Similarity Search (FAISS) library, to index the vector representations and permit searches through one or more indexes described in this disclosure. After storing wager-related data in a database and indexing the wager-related data with a set of indexes, some embodiments may persist the database and the set of indexes.

In some embodiments, after persisting a vector store, a data processing system may reuse the vector store for future queries while maintaining a time-tracking element to ensure that the persisted data remains fresh with respect to a data expiration time. For example, a data processing system may receive a prompt from a player at a later time after persisting a first vector store and a second vector store and determine index ages for the first and second vector stores at the later time. The data processing system may then determine whether the index age satisfies a set of index age thresholds. For example, some embodiments may determine whether the index age satisfies a maximum age threshold indicating that the index is not too stale. The data processing system may determine a result indicating that the index age satisfies the set of thresholds and, in response, access the vector store to retrieve one or more wager scenario records or other wager scenario-related data. By checking the date of an index or an index portion instead of merely the date of wager scenarios, some embodiments may increase the likelihood that accurate data is being retrieved. In some embodiments, an index configuration may permit both exact searches, nearest neighbor searches, and semantic similarity searches, increasing the likelihood of accurately and comprehensively obtaining wager scenario data for different wager scenarios.

In some embodiments, a data processing system may maintain one or more indexes to track wager opportunities by a wager line value (sometimes also referred to as “market line,” “line value,” or “line”). Alternatively, or additionally, the data processing system may also maintain one or more indexes to track wager opportunities by another category or value associated with a wager, such as an entity type, wager type, or related gaming group system. For example, a data processing system may maintain a first index that tracks wager opportunities by entity names (e.g., a sporting team name), event identifiers (a sporting team match-up and an associated event date), and default market line values. The data structure may maintain a second index that tracks wager opportunities by entity names, event identifiers, and alternate market line values. The data structure may maintain a third index that tracks wager opportunities by entity names, event identifiers, and SGPs (e.g., an index that associates moneyline or straight bet wagers with wager scenarios involving a sports team player accomplishing a task).

In some embodiments, a data structure may be a combination of other data structures, where separate data stores may be indexed in different ways. For example, some embodiments may store a first vector database indexed by default market line values and store a second vector database indexed by alternate market line values. In some embodiments, the indexes may be configured to permit fast, real-time updating. For example, one or more indexes may be configured as a locality-sensitive hashing (LSH) or product quantization (PQ) method to permit easy or fast updates to an index for a vector database. Alternatively, some embodiments may use a Navigable Small World (HNSW) database. As described elsewhere in this disclosure, maintaining separate indexes may permit the fast retrieval of wager scenario data characterized by a player-provided prompt and of wager scenario data that is relevant to but not explicitly requested by data in the player-provided prompt.

In some embodiments, a data processing system may use an externally facing language model to generate update or update recommendations for indexes. The real-time nature of wagers and ad-hoc construction of live events is such that odds values, wager amounts, and other wager properties may dynamically change between the creation of a wager record and the time that an event outcome for the wager is realized. In many cases, real-time events such as weather, injury, or other unpredicted outcomes may be communicated via a messaging platform instead of a betting system. In response, some embodiments may update an index to associate a record with a wager scenario record even before the wager scenario record is updated in response to a detected message, where some embodiments may indicate that a record has been updated based on the detected message. By dynamically updating an index independently of updating the bets themselves, some embodiments may reduce the time and computing resources required to present a player with relevant wager opportunities based on new information.

A wager opportunity or other wager scenario can correspond to a predefined wager type. For example, a data processing system can generate and manage a collection of wager opportunities. The wager opportunities may be directly tied to live events. Examples of wager opportunities can include Team A to win the game, Team B to win the game, total points scored over/under X points, Team A to win by X or more points, and Player C to score over X points, among others. A wager opportunity may also be classified by one or more wager types. A wager type may be a classification for a wager opportunity that indicates a particular type of wager with that wager opportunity. The wager type may include a category indicating whether a wager opportunity is a straight bet (e.g., a bet on a single outcome), a multi-game parlay that combines multiple legs from multiple games into a single wager opportunity, a same-game parlay (SGP) wager that combines multiple legs from the same game into a single wager opportunity, a point spread in which a quantitative outcome occurs by more than a specified margin, a moneyline bet in which a team is selected to win, an over/under bet in a win condition is that the combined total points scored by both teams of a two-team competitive event satisfies a threshold, a Futures bet on a long-term outcome, a prompt that on a specific event within a game, or a teaser that permits a player to adjust a point spread, among others. In some implementations, wager opportunities or wager scenarios may include individual legs that can be automatically combined into single-game parlay wagers or multi-game parlay wagers in response to corresponding requests made by users. In such implementations, the

In some embodiments, a data processing system may receive a prompt in association with a player profile (BLOCK 204). A prompt may be provided by a client device or client system, such as the client system 115. For example, a player may enter a prompt into a graphic user interface of an application executing on the client system. The application may then communicate the prompt to the data processing system 105, which may then perform one or more operations described in this disclosure to retrieve and present a set of wager scenarios to the player. Some embodiments may receive a prompt in text form (e.g., via the application interface 185). The prompt may be received via a chat interface that is connected to a language model, where a machine learning system may use the language model to respond to the prompt, as described elsewhere in this disclosure.

In some embodiments, the prompt may include a request for a wager type recommendation. For example, a received prompt may include the phrase “what wagers are available for event EVENT01?” As described elsewhere, some embodiments may provide an output message that identifies one or more wager scenarios and their corresponding wager types as recommended wager scenarios or recommended wager types. Furthermore, in some embodiments, a data processing system may receive prompts associated with a player profile via a session between a player's client device and a betting platform. A session may include a conversational interaction between a player and the betting platform. A session may be initiated when a player accesses an application (e.g., via a web browser or a native application installed on a client device) and concluded upon logout or application closure. In some embodiments, a session may be identified, tracked, and associated with a player profile. In some embodiments, a data processing system may store, in an in-memory storage, data previously provided by a player or provided to the player during a session and, at a later time during the same session, retrieve the previously stored data.

In some embodiments, a player profile and/or the prompt may indicate a preference for a particular wager type or a preference to filter out a particular wager type. For example, a player profile may indicate that a player will always choose to pursue a straight bet in lieu of other wager types, such as a parlay or a point spread. Alternatively, or additionally, a player profile may store previous player-provided prompts or conversations with one or more agents. Some embodiments may apply analytical models such as Latent Dirichlet Analysis (LDA) to determine a preference for a particular wager type and, in a response, indicate the preferred wager type.

In some embodiments, a data processing system may obtain a prompt that includes a player's initial request for a wager recommendation. The prompt can include a request for a wager on one or more specific outcomes, such as a team to win, a team member to score, a specific point spread, etc. In some embodiments, the prompt may provide sufficient information to determine specific live event(s) and outcome(s) requested by the player. Alternatively, the prompt may require additional information from either the player or another data source to effectively search for wager opportunities. For example, some embodiments may receive the prompt “Athlete_firstname Athlete_lastname to score a touchdown,” in which the prompt includes an entity identifier but not an explicit live event identifier. As described further, some embodiments may search for a set of live events in which an entity titled “Athlete_firstname Athlete_lastname” may be capable of scoring a touchdown. Alternatively, or additionally, a data processing system may receive a prompt “Athlete_firstname Athlete_lastname to score a touchdown at the Team X v. Team Y game on 01/01/20XX,” in which the prompt includes sufficient information to identify a specific live event.

In some embodiments, the prompt can include an exploratory request for information about a live event, such as odds value or different wager types for a particular event. In some embodiments, the prompt can include seeking suggestions for potential wagers based on player preferences or available options, requesting to add, remove, or modify wagers on a bet slip, and inquiring about account balance, wager history, or transaction details, among others. In some embodiments, the data processing system can receive and process subsequent prompts or requests for modifications. For example, a player can request an update/modification to a previously generated wager recommendation or seek additional information about a specific wager. In some embodiments, a data processing system can process the secondary prompts in conjunction with the original request to transmit relevant and updated information. Modifying a wager/wager scenario may include requesting additional or alternative legs to be included in a parlay-type wager or an exotic wager. Modifying a wager may include removing legs from a parlay or exotic wager.

Some embodiments may provide the prompt to a query-building language model to obtain a set of queries (BLOCK 206). In some embodiments, a query-building language model may include or have access to an LLM, where providing the prompt may include providing the unprocessed prompt of a player to the LLM. A prompt that is provided to a language model that then generates a query may be described as a query-building prompt. In some embodiments, an unprocessed prompt may be a query-building prompt. Alternatively, or additionally, a prompt may first be processed to extract intents, identifiers, values, or other data before being used as a query-building prompt. In some embodiments, the LLM used as or as a part of a query-building language model may be the same as an LLM used in a downstream operation, such as an operation to generate an output to be presented to a player. Alternatively, the query-building language model may be different from an LLM used in a downstream operation, such as an LLM used to generate an output that is then presented to a player via a client device.

Due to the number of events that may be retrieved, a data processing system may retrieve a set of criteria associated with or otherwise based on a wager type recommendation. For example, some embodiments may first determine that a prompt includes a request for “straight bet” wager types and, in response, obtain a set of criteria associated with a “straight bet.” The set of criteria may limit identifiers to a subset of entities permitted to be listed in a straight bet, limit a set of identifiers to listing only exactly two entities, etc. Determining that a set of identifiers parsed from an LLM satisfy criteria associated with the wager type can reduce the likelihood that too many wager scenarios are retrieved or that irrelevant wager scenarios are retrieved during a downstream data retrieval operation.

In some embodiments, a data processing system may perform operations to retrieve prompt-derived data from a query-building prompt, such as intents, event identifiers, entity identifiers, etc. The LLM may act as a query-building language model by outputting a database query for a database to receive a prompt. Alternatively, or additionally, a data processing system may use one or more functions, services, or other operations to further modify the output of the LLM to build a database query. It should be understood that a query-building language model may refer to the LLM itself or to a combination of the LLM and other pre- and post-processing applications, functions, scripts, services, or executions of program code used to generate a query.

In some embodiments, a data processing system may classify a set of intents based on the prompt. In some embodiments, a data processing system can process a player's prompt to determine the player's intent or intended action. The data processing system can assign a specific wager type to each wager opportunity to categorize the wager opportunities. The wager types can include moneyline, point spread, over/under, player props (betting on the performance of individual players), parlay (combining multiple bets into a single wager), and single bet, among others. In some embodiments, the classification process can include identifying the wager type (e.g., moneyline, point spread, parlay, etc.) and relevant entities (e.g., teams, members of the team, individuals, etc.) within the prompt.

After receiving a player's prompt, a data processing system may parse the prompt into a sequence of strings (e.g., a plurality of text blocks) to detect one or more intents, requested entities, etc. For example, a computer system may receive the input request “Parlay AnimalsTeamName to win and HistoryTeamName to cover.” The computer system may decompose the request into a plurality of text chunks that include “AnimalsTeamName to win” and “HistoryTeamName to cover.” The computer system may then extract a live event name, proposed outcome, a set of intents, or wager line from the input request. For example, the computer system may derive the intent “[TEAM] to win” as an intent after determining that AnimalsTeamName refers to a sports team using a rule-based subsystem. In cases where an intent is not interpreted as a wager type, some embodiments ay then use a rules-based system or machine learning classification system to associate an intent with a wager type. For example, some embodiments may provide the first intent “[TEAM] to win” as an input to a machine learning system and, response receive a classification of “straight bet” as a wager type, and then use the first intent or the wager type as part of the set of intents used to retrieve wager scenario data. For example, some embodiments may retrieve a subset of wager opportunities that are categorized as being a selected subset of the plurality of wager types after this subset of the plurality of wager types is limited by one or more phrases in a player-provided prompt. In some implementations, intents may be parsed that relate to a request for information relating to different types of wagers, for example, from prompts such as “How can I wager on both [Team A] and [Team B] this weekend?”, “what parlays can cover both [Athlete A] and [Athlete B]”, or similar prompts.

In some embodiments, a prompt may identify a participant or a plurality of participants of one or more live events, where the identification of the set of participants may cause a data processing system to identify an associated set of live events. In some embodiments, the data processing system may then use one or more identifiers of the set of participants or the set of live events to form one or more additional intents. As described elsewhere in this disclosure, a data processing system may use a set of intent as part of an input context for a query-building LLM, may directly retrieve one or more records based on the set of intents, or may filter a retrieved set of records with the set of intents.

In cases where information used to determine a query or filter a query result is not provided in the input request, some embodiments may simply leave the text chunk parameters blank or substitute a default value. For example, in some embodiments, a data processing system may determine that one or more line values are not present in a prompt for retrieving a set of wager scenarios, where a set of intents should include a set of intents to increase the accuracy of a search. In response, some embodiments may update an input context or other data field with a default line value. For example, some embodiments may assign the value “110” as a default line value to be used as part of set of intents.

In some embodiments, a data processing system can process the prompt and its associated classification and can generate an input context via the intent classifier subsystem. The input context can include a player's intent that indicates what the player is trying to achieve, such as placing a bet or getting information, depending on the prompt. For example, a data processing system may use a rules-based method to determine an intent based on keywords, patterns, or data provided in association with a prompt (e.g., a player-selected category). Some embodiments may provide the prompt to a machine learning classification model, such as a Naïve Bayes classification model, a support vector machine, random forest model, neural network, etc. Furthermore, some embodiments may directly use an LLM to determine an intent. Alternatively, some embodiments may determine an intent independently of the LLM.

In some embodiments, the input context can specify the wager type and include relevant entities, such as teams or players. In some embodiments, the input context can include contextual information relevant to the player's request. For example, if a player enters the prompt “Bet $100 on Team A to win,” the input context can include the intent to place a bet, wager type as moneyline, team as Team A, and the bet amount as $100, providing structured information to the language model to generate the output in accordance with the input context.

In some embodiments, the data processing system may generate a document containing text indicating the most relevant wager opportunities applicable to a player's prompt. For example, a data processing system may extract a set of bet selections and stored this set of bet selections as a list of strings. The data processing system may contain keywords or semantics received from the player's input. The data processing system may then search through one or more indexes for a top-K matching outcomes for each of the listed strings representing a respective that selection. The data processing system may then compile the top-K matching outcomes into a document and then use this document as an input to determine a set of intents and an associated set of text chunks representing single selections of a wager opportunity. Some embodiments may then update a player-specific data structure to indicate one or more wager opportunities based on the associated set of text chunks.

In some embodiments, a data processing system may determine that one or more intents are out of scope and prevent use of more expensive computing resources based on the presumed intents. For example, a data processing system may obtain a candidate intent “navigation guidance” based on a prompt that includes “tell me how many miles I must drive to get to the company headquarters.” In response, the data processing system may determine that “navigation guidance” is not an intent within a stored set of permitted intents, such as “wager scenario data retrieval,” “live event data,” “UI navigation,” etc. Based on such a result, some embodiments may either prevent further actions based on the out-of-scope intent (e.g., prevent exploring a vector space based on the out-of-scope intent) or prevent actions based on other intents provided in the same prompt as the out-of-scope intent. For example, some embodiments may determine that a first set of intents extracted from the prompt are within scope and that a second set of intents extracted from the prompt are not within scope. In response, some embodiments may perform search operations and LLM utilization operations based on the first set of intents and not on the second set of intents. In some embodiments, a data processing system that detects one or more out-of-scope intents from a prompt may then send a fixed message back to a client device to display a message indicating that one or more detected intents of the prompt were out of scope. For example, a data processing system may cause a client device to display a fixed message reciting “I'm sorry, we are not able to do that.”

In some embodiments, a data processing system may use classifications for intents and prompts to indicate what type of information to retrieve. For example, some embodiments may determine whether a prompt is an exploratory prompt (e.g., comprises an exploratory intent) or a follow-up prompt. In some embodiments a prompt may be exploratory when one or more extracted intents are indicated to be an exploratory intent associated with event information retrieval or otherwise links to descriptive information resources or text. For example, a data processing system may determine that a prompt is an exploratory prompt after sending the prompt to an embedding model to extract a set of vector space values and determining that a set of intents associated with one or more of the vector space values is associated with the exploratory intent “general information retrieval.” In response, the data processing system may retrieve a set of text data, such as documents, articles, or other types of text data associated with the set of intents. In some embodiments, a data processing subsystem may retrieve a set of text data that include or are tagged with one or more keywords include in the set of intents or related to the set of intents. For example, a data processing system may respond to an intent “information about Coelacanths” by retrieving data about the sports team “City State Dasypogons,” the sport “SportsBall01” played by this sports team, and publicly available betting history information about this team.

After receiving an exploratory prompt, a data processing system may receive a follow-up prompt that may result in the retrieval of one or more wager scenario records. For example, a data processing system may receive a first prompt reciting “tell me about the performance of CityState Dasypogon.” In some embodiments, the data processing system may use a machine learning model to classify the first prompt with a first intent category indicating that the first prompt is an exploratory prompt, where this machine learning model may include an LLM or a simpler machine learning model (e.g., a non-deep neural network). In some embodiments, the data processing system may receive a follow-up prompt “show me wagers for the Dasypogons.” When presenting data, a data processing system may first detect indications of one or more line values provided by the descriptive information resources retrieved by data processing system after the exploratory prompt. The data processing system may then receive a second prompt and categorize the intents of the second prompt with a second intent category associated with wager scenario retrieval. For example, some embodiments may determine that a follow-up prompt includes the intent “obtain wagers for CityState Dasypogons” and, in response, perform one or more operations described in this disclosure to retrieve wager scenario data. Additionally, the data processing system use the one or more line values as parameters for a query or to calculate parameters for the query. For example, some embodiments may use the one or more line values, and the set of intent categories to generate an input for a query-building LLM.

After receiving a large language model response from a query-building language model, some embodiments may perform operations to modify, add, or remove one or more values from the response to generate a more accurate query. For example, a response may include wager types, probability values, other numeric values, event identifiers, other identifiers, or other query-relevant elements. Some embodiments may parse a query-building language model output to detect these query-relevant elements, such as parsing the model output to retrieve values indicating a wager type recommendation, an initial probability value or other value associated with that wager type recommendation, and a set of identifiers associated with that probability value. For example, some embodiments may obtain, from a query-building language model, a model-generated response that recites a graphQL query that includes, “query GetStraightBetDasypogons($limit: Int=50, $now: DateTime!, $threeMonthsFromNow: DateTime!) {bets(filter: {category: “straight bet”, percentage: “30%”, dateRange: {startDate: $now, endDate: $threeMonthsFromNow}, team: “Dasypogons”}, first: $limit) {edges {node {id eventID category percentage date team odds description}} pageInfo {hasNextPage endCursor}}}.” Some embodiments may then parse the LLM response to retrieve the wager type recommendation “straight bet,” the initial probability value “30%,” and the identifier “Dasypogons.”

In some embodiments, a query-building language model or other LLM may fail to accurately account for numeric values in query parameters, such as the range limits of a query due to limitations on a player's knowledge on probability values and likelihoods when generating a response. When a model-generated response is used a query, such a failure can cause significant amounts of unnecessary consumption of resources, inaccurate results, or even a total failure to retrieve relevant data. Furthermore, such limitations are exacerbated by the ad-hoc nature of wager scenarios, in which different identifiers may be associated with different ranges. For example, wager scenarios for straight bets associated with the identifier “Team1” may have a permissible range of +5% to −5%. In contrast, straight bets associated with the identifier “Team2” may have a permissible range of −2.5% to +10%. Some embodiments may modify an initial probability value based on these probability ranges to retrieve a set of calculated probability values. Some embodiments may then modify a model-generated response based on the set of calculated probability values to form an augmented LLM response.

For example, after determining a range of probabilities 25%-35% based on an event identifier and a wager type recommendation, some embodiments may generate an augmented query that includes the query portion “query GetDasypogonsEvents($now: DateTime!, $threeMonthsFromNow: Date Time!, $minProbability: Float=20.0, $maxProbability: Float=30.0, $limit: Int=10) {events(filter: {dateRange: {startDate: $now, endDate: $threeMonthsFromNow}, category: “straight bet”, probabilityRange: {min: $minProbability, max: $maxProbability}, team: “Dasypogons”}, first: $limit) {edges {node {id eventDate category probability team description odds}} pageInfo {hasNextPage endCursor}}}.” Some embodiments may then apply a post-processing step to the model-generated response to replace “$minProbability: Float=20.0, $maxProbability: Float=30.0” with “$minProbability: Float=25.0, $maxProbability: Float=35.0” for form an augmented model-generated query.

Some embodiments may determine an input context based on relevant wager scenarios obtained by searching an indexed data structure using the query (BLOCK 208). As described elsewhere in this disclosure, some embodiments may use a query-building language model to generate a query. In some embodiments, a generated query may indicate a wager line or other wager property that characterizes a wager scenario. Furthermore, as described elsewhere in this disclosure, an indexed data structure may be indexed by multiple indexes. For example, the set of indexes used to index an indexed data structure may include a first vector index and a second vector index. The vector indexes may associate intents with wager scenarios related to those events. However, traditional methods of generating a query based on player intent may be insufficient because a player's intent may be obfuscated due to a player's failure to understand the details of an event or alternative outcomes of an event.

In some embodiments, a data processing system may take advantage of indexing structure or arrangements to reduce the use of computing resources by an LLM or the network costs associated with using an LLM. For example, some embodiments may generate and maintain a first vector index and second vector index. The first vector index may map or otherwise associate a set of live events with a set of entities, a plurality of wager types, and a first set of wager opportunities. Additionally, the second vector index may map or otherwise associate the set of live events or the plurality of wager types with the set of entities and a second set of wager lines different from the first set of wager lines. For example, some embodiments may use the set of intents as inputs for an encoder model that outputs a set of vectors. The set of vectors may be used as embedding representations in a vector space representing a space of intents, where some embodiments may then use the set of vectors to explore one or more vector indexes and retrieve data.

In some embodiments, a data processing system may update a player-specific data structure that indicates different wager opportunities selected by a player (e.g., selected via an application interface). In some embodiments, this player-specific data structure may be specific to a communication session and stored in an in-memory storage. As described elsewhere in this disclosure, some embodiments may use the player-specific data structure to map outcome identifiers or other identifiers to a player's wager opportunity selection. Furthermore, the wager properties or other data related to a wager scenario may be stored in an in-memory storage and retrieved after receiving a new prompt indicating the wager scenario. For example, a data processing system may store odds values, line values, outcomes, or other additional values associated with a set of wager scenarios for an event. After receiving a request that indicates the event (e.g., via an event identifier, via receiving data that can be mapped to the event, etc.), a data processing system may retrieve, from in-memory storage, these additional values associated with the event. For example, a data processing system may retrieve outcome data for a wager scenario for an event, where the outcome data may include Boolean data, categorical data, other structured data, or free-form text data that indicates a particular team winning, a team winning by a certain number of points, a particular event participant performing a task, etc.

In some embodiments, a data processing system can track the number of times a particular wager has been placed. As players place wagers, the data processing system can increment a wager counter within the storage. In some embodiments, the data processing system can track changes in wager odds such that the data synchronization may be maintained in real time. In some embodiments, the data processing system can process the wager request and update the associated player profile, which may include recording the wager details, calculating winnings or losses, adjusting the player's account balance, and more. In some embodiments, when the player ends the session by logging out or closing the application, the data processing system can store relevant session data such as player preferences, betting history, and cart items in the profile manager subsystem for future use. In some embodiments, the data processing system may dynamically generate and present a message to a player that information previously provided to the player is no longer accurate and that the parameters of a wager opportunity have changed.

As described elsewhere in this disclosure, wager scenarios may be classified in different ways with respect to other wager scenarios. For example, each wager scenario may be classified as an alternate offer or a default offer for a wager scenario, where such a classification may be used to determine which database is queried to retrieve one or more wager opportunities. For example, some embodiments may obtain the intent “Athlete9125 scores hit at event EventID1053.” Some embodiments may first augment a search with an indicated default line value (e.g., “−110”) and search a first index of a first vector database using the index values “−110” and a vector representation of “Athlete9125” and event types assigned to the event “EventID1053.” Furthermore, some embodiments may search for a set of alternate line values associated with “EventID1053” or “Athlete 9125.” Some embodiments may further search a second index of a second vector database using the set of alternate line values and the vector representation of “Athlete9125” and the event types assigned to the event “EventID1053.”

In some embodiments, a data processing system may use data extracted from the prompts to retrieve wager opportunity data from a database using a set of indexes. As described elsewhere in this disclosure, the volume of data available to wager opportunities can be overwhelming for a single-index search. As described elsewhere in this disclosure, a wager opportunity may be classified as a default wager opportunity with respect to a wager intent, alternate wager opportunity with respect to the wager intent, or grouped as a related wager with respect to the wager intent. Some embodiments may use separate indexes that are independently maintained with respect to each other, where each index may link wager opportunities with each other or player intents.

In some embodiments, the data structure used to store wager opportunity data may be indexed data structure that is indexed by one or more vector indexes. A vector index may be an index for a data structure that permits efficient retrieval of hyper-dimensional data based on similarity (e.g., distance to a corresponding vector). For example, a set of wager opportunities with similar traits may be associated with a set of vectors of a search space, such that a search for an opportunity of the set of wager opportunities may search for vectors within or near the set of vectors within the search space. Furthermore, some embodiments may limit the distance of exploration to occur within a tolerance boundary characterized by a game parameter tolerance. For example, if a tolerance boundary is equal to 0.1, some embodiments may modify a search query based on a default tolerance boundary or player-specific tolerance boundary such that the modified search query reduces a search radius to be within the tolerance boundary 0.1. In some embodiments, a game parameter tolerance may be related to but not explicitly defined by a query.

Alternatively, or additionally, some embodiments may determine a tolerance modification value based on the tolerance boundary and modify one or more retrieved wagers based on the tolerance modification value. For example, some embodiments may retrieve a first set of wager scenarios and determine that one or more of them do not satisfy a risk parameter or other game parameter. Instead of discarding the wager, some embodiments may dynamically modify the wager to satisfy the wager parameter, thereby reducing the need to perform an additional search for additional wager opportunities or similar wager opportunities. For example, some embodiments may retrieve first set of wagers and detect that a wager opportunity for an outcome has an odds value that exceeds a player's required odds value. Some embodiments may modify the wager to decrease the odds value while decreasing the wager payout in order to satisfy the player's indicated risk tolerance.

As described elsewhere in this disclosure, some embodiments may select multiple sets of wager scenarios for possible presentation to a player. For example, a data processing system may retrieve a first set of wager opportunities or other wager scenarios using a first index and determine a second set of wager opportunities or other wager scenarios using a second index. Some embodiments may generate an input context by aggregating text from one or more records of the first set of wager opportunities and one or more records of the second set of wager opportunities to perform an aggregated context text. In some embodiments, the aggregated context text may be structured as to indicate which portion of the aggregated context text corresponds with which wager scenario, where such indications may be important to maintain specificity for wager scenarios and to reduce the risk of inaccurate associations between wager descriptions and wager recommendations in an output of a language model.

Some embodiments may use multiple vector indexes that are different from each other to increase retrieval speed from a data structure. For example, after receiving a first prompt, some embodiments may use a first vector index that indicates one or more wager opportunities characterized by a set of live events associated with a set of entities (e.g., teams) and a set of wager types (e.g., moneyline, parlay, etc.). Some embodiments may use the same first prompt to search a second vector index that relates to a player intent with alternate wager opportunities that may differ from the initial player intent. For example, if the latent space of a vector index includes a line value as a dimension of the vector space, some embodiments may vary the line value of a prompt-derived vector representing a first wager opportunity.

While conventional wager systems may perform indexed searches through a database of wagers, such configurations may be limited in cases where a real-time response is required during massive concurrent gaming events. Some embodiments may overcome these issues by generating, maintaining, and using multiple vector indexes that are maintained to target different types of wager scenarios related to tokens or derived tokens. For example, some embodiments may generate different embedding models associated with different domains relevant to wager scenarios. For example, some embodiments may use a first domain-specific embedding model trained to target wager scenarios themselves, a second domain-specific embedding model trained to target related scenarios that can be formed into parlays, etc.

When using a vector store of an index, some embodiments may perform a nearest neighbor search. For example, after using a prompt to generate a search query used to navigate a vector store, some embodiments may perform an exact index search in the vector store to retrieve a first wager opportunity or other type of wager scenario. Some embodiments may then retrieve one or more second wager scenarios in a neighboring region in the latent space as a result of performing the nearest neighbor search and then display the data involving the one or more second wager scenarios, as described elsewhere in this disclosure.

In some embodiments, a player may intend to formulate a parlay wager or obtain recommendations for parlay wagers, such as different-event parlays, single-game parlays (SGPs), other types of exotic wagers, etc. In some embodiments, a player may reflect this intent by using keywords such as “parlay,” “SGP,” or “exotic wager” in their prompt. After detecting this intent, a data processing system may limit a selection of wager types such that the selected subset of wager types is limited to wager types that permit or even require multiple conditions to be formed to finalize a wager scenario. Then, when forming a query used to retrieve data for one or more wager scenarios, the data processing system may include this limitation in the query.

Some embodiments may generate an output message identifying a subset of wager scenarios based on the input context or the prompt using a large language model (BLOCK 210). Some embodiments may provide the input context and a player-provided prompt to an LLM, where the output of this LLM may then be presented to a player. By having first used a query-building language model to retrieve data for the input context, an LLM that receives this input context is significantly more likely to generate accurate outputs that are responsive to a player's initial prompt. It should be understood that this LLM may be the same as the language model of the query-building language model. Alternatively, or additionally, the LLM of the query-building language model may be different from the query-building language model. In some embodiments, the query-building language model and the LLM used to generate the output presented to a player may have the same architecture. Alternatively, the query-building language model and the LLM used to generate the output presented to the player may have different architecture with respect to each other.

In some embodiments, a data processing system may determine the number of wager types to use by referring to historical data. In some embodiments, the input context can include a flag or identifier that indicates that the wager is a parlay and data characterizing the parlay (e.g., whether the parlay comprises three legs, a field with the value of the parlay, a list of the individual legs of the parlay, etc.). In some embodiments, a language model can generate data structures corresponding to the wager properties or other wager-relevant data associated with one or more wager scenarios, such as odds values, payout information, instructions for generating textual explanations, visual representations, or other graphical elements. In some embodiments, a data processing system or client system may use a language-model-generated output to display a generate or update an application interface. In some embodiments, the application interface may includes a set of interactive elements within the application interface, such as buttons, links, or other clickable components to select a wager scenario for play, modify the wager scenario, or select another wager scenario.

For example, some embodiments may determine, from a plurality of historical wagers associated with a player record for a player, that the player only engages in straight bets or SGPs. In response, the data processing system may limit the number of selectable wager types to straight bets and SGPs. Furthermore, some embodiments may determine a distribution of selected wager types based on the ratio of used wager types in the historical data and, in response, modify the selection or presentation of wager opportunities to that wager type.

The data processing system may generate an output indicating a subset of the wager opportunities (BLOCK 210). In some embodiments, a data processing system may provide an input context and a prompt (e.g., a player-provided prompt) to an LLM and present an output of the LLM to a player via a client device. In some embodiments, the output of an LLM may be modified or augmented with betting information. For example, a data processing system may provide, as part of a prompt for an LLM or in association with the prompt, data for a list of wager scenarios (e.g., wager identifier, wager amount, wager odds, wager participants, associated wagers, whether they are a direct bet wager or an alternative wager, etc.). In some embodiments, the LLM may be limited to selecting wager scenarios from the scenarios provided in an input context. By limiting the LLM to presenting data derived from the input context, the LLM may be freed from constant re-training.

Some embodiments may select or modify parameters of the LLM or inputs to the LLM before using the LLM to produce an output message. For example, some embodiments may include additional context information in an input to the LLM or with an input to the LLM to indicate that a particular type of client device (e.g., mobile device, native application, laptop, etc.) is a designated target for an output message. In response, the LLM may modify the format of data from a first data type or format of the data to a different data type or format of the data. By bifurcating information retrieval from generating an output message, a data processing system may reduce the need to re-train an LLM for updated wager data based on real-time updates to possible wagers.

In some embodiments, a data processing system can provide the output message to a client device (BLOCK 212). In some embodiments, the data processing system can transmit the data structure generated by the language model to the client system, for example, over the network. The data structure can include information about a set of wager scenarios, odds values, or graphical elements relevant to a wager scenario, etc. The client system associated with the client device can parse the data structure and render it as an application user interface element. In some implementations, the client system can cause the application interface to generate multiple graphical elements and display different visual representations of wagering options. In some implementations, the client system can dynamically update the graphical elements based on the updated data structures.

### C. Recommending Wagers Based on Player-Selected Gaming Tolerances

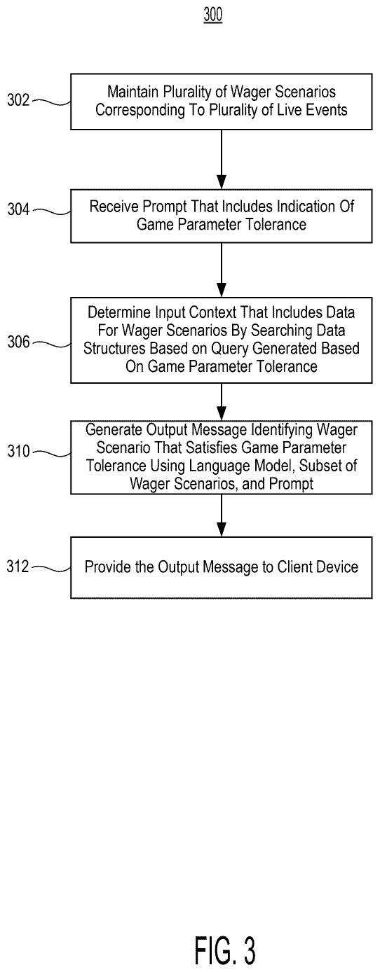

FIG. 3 illustrates an example flow diagram of a method for filtering wager opportunities associated with live events based on a player-generated prompt, in accordance with one or more embodiments. The method 300 may be executed, performed, or otherwise carried out by an interactive server or a system. A data processing system (e.g., the data processing system 105) may be remote to one or more client systems (e.g., the client system 115) and one or more machine learning systems (e.g., the machine learning system 120) and can communicate with the one or more client systems or the one or more machine learning systems via a computer network (e.g., the network 110). In a brief overview of method 300, the interactive server or the system can maintain a plurality of wager opportunities corresponding to a plurality of live events (BLOCK 302), receive a prompt that includes an indication of a game parameter tolerance (BLOCK 304), select a subset of a plurality of wager scenarios based on the indication of game parameter tolerance determined based on the prompt and respective odds value of the plurality of wager scenarios retrieved via an indexed data structure (BLOCK 306), generate an output message identifying a wager scenario that satisfies game parameter tolerance using a language model, a subset of wager scenarios, and the prompt (BLOCK 310), or provide the output message to a client device (BLOCK 312).

In some embodiments, a data processing system can maintain a plurality of wager opportunities corresponding to a plurality of live events (BLOCK 302). As described elsewhere in this disclosure (e.g., operations described BLOCK 202 or BLOCK 402), the data processing can perform various operations to maintain databases, datasets, data stores, or other data structures usable for storing and retrieving wager scenarios. For example, a data processing system may store, in an indexed vector database, records for wager opportunities, where the indexed database may be indexed by one or more vector indexes.

In some embodiments, a data processing system may assign categories or values to records of wager scenarios based on already-known values for the records of wager scenarios. For example, for each respective scenario of a set of wager scenarios, a data processing system may generate a respective weight value based on a respective odds value for that respective scenario (e.g., by using an example formula such as “weights=100/(Abs(odds value)+100”) in the case of an American-style odds value). In some embodiments, the data processing system may detect external or internal updates to a respective wager scenario record and modify the record to indicate a set of respective odds changes. In some embodiments, a data processing system may generate or update an index to seek out updated records, where some embodiments may take advantage of an initial search to perform a more limited search of the same wager scenario records to determine whether an update to one or more of the wager scenarios occurred.

In some embodiments, each respective record for a wager scenario or wager type may indicate a respective risk category. In some embodiments, a data processing system may receive an indication of a risk tolerance based on a prompt, assign a risk category to the prompt, and then restrict searches to wager scenario records indicating the risk tolerance. By restricting searches for gaming options to a particular set of wager types or options associated with a risk category, some embodiments may also make use of indexes that are restricted to records associated with that risk category.

In some embodiments, the vector indexes may be dynamically generated or updated based on one or more prompts. A data processing system may generate a first ordered tolerance category from a series of tolerance categories based on a game parameter tolerance indicated in the prompt. For example, the data processing system may generate a tolerance category indicating a particular range of risk tolerances that a player is known to accept, where a risk tolerance may indicate an overall score that a player is willing to lose, a maximum amount that a player is willing to lose during a gambling session, a maximum amount that a player is willing to lose during a set of related gambles, a maximum amount that a player is willing to lose during a period of time, etc. Furthermore, when generating or updating a data structure, some embodiments may, for each respective wager opportunity of a plurality of wager opportunities, select a respective category.

In some embodiments, a data processing system can receive a prompt that includes an indication of a game parameter tolerance (BLOCK 304). As described elsewhere in this disclosure (e.g., operations described BLOCK 204 or BLOCK 404), the data processing system can receive a prompt. In some embodiments, the prompt can include or otherwise indicate various types of game parameters or a tolerance range for the game. In some cases, the tolerance can characterize a limit to a computing resource consumption of a game, where the limit may influence the performance of the game. For example, the tolerance may include a number of computing nodes to contact or activate for the game, the maximum number of processors to use to execute the game, etc. Alternatively, or additionally, the game parameter tolerance may indicate a risk tolerance related to a score or metric used in a game itself. For example, a game parameter tolerance may indicate a number of points that a player is willing to lose per wager, per series of wagers, per period of time, or over a recorded lifetime of wagers.

In some embodiments, a data processing system can determine an input context that includes data for wager scenarios by searching the data structure with a query generated based on the game parameter tolerance (BLOCK 306). As described herein (e.g., operations described for BLOCK 206 or BLOCK 208), some embodiments may use a language model to build a query that is then used to search for one or more wager scenarios. Alternatively, or additionally, some embodiments may determine a set of identifiers, intents, categories, or vectors from a prompt and retrieve a set of wager scenario data based on the set of identifiers, intents, categories, or vectors. In some embodiments, a query may either explicitly or implicitly limit a designated game parameter to be within an indicated game parameter tolerance.

In some embodiments, a data processing system may further use a respective odds value of a respective scenario of the plurality of wager scenarios when selecting the respective scenario for the inclusion or exclusion from the subset of wager scenarios. For example, a data processing system may receive a prompt requesting the retrieval of a subset of wager scenarios having a probability value equal to or less than 10% (or another threshold odds value). Some embodiments may then perform a pre-filtering operation by preparing an input context to include the phrase “select only wager scenarios having a probability equal to or less than 10%.” Alternatively, as described elsewhere in this disclosure, some embodiments may perform a set of post-filtering operations to determine that a wager or series of wagers satisfy the indicated risk tolerance. Such post-processing may be especially helpful in cases where an LLM generates instructions that fail to accurately account for the effects of combining wagers or non-independent wagers. In some implementations, the data processing system can automatically infer/classify the threshold based on natural language in the prompt.

In some embodiments, a data processing system may assign a risk category of a plurality of risk categories to a game parameter tolerance. Associating the game parameter tolerance with a risk category may reduce the number of records searched or returned from the search. For example, some embodiments may, via a machine-learning model of the set of language models 190 or rules-based subsystem, assign risk category “point spread risk” to a risk tolerance provided by a player based on a player-provided prompt. In response, some embodiments may restrict the subset of wager opportunities associated with this risk category, such that only wager opportunities for which a point spread is applicable will be retrieved (e.g., some embodiments may retrieve scoring wager scenarios without retrieving moneyline wager scenarios).

Some embodiments may select one or more wager scenarios from a plurality of wager scenarios by using a set of game parameter tolerances (e.g., historical odd values, historical wager types, etc.) stored in historical wager data identified in a player profile. For example, a data processing system may receive a prompt from a player has an associated profile record and retrieve a set of records of a set of historical wagers selected by the player or obtain data associated with or derived from the historical wagers (e.g., a set of game parameter tolerances previously provided by the player or otherwise stored in a player profile record). In some embodiments, the set of historical wagers may indicate one or more tolerances that the player has limited. For example, a data processing system may detect that a player has accepted wagers having a probability value in the 45% to 55% range based on the historical wagers accepted by the player. In response, the data processing system may set the risk tolerance field of an input context for a prompt that is sent to a query-building LLM to be equal to 55%. Alternatively, or additionally, some embodiments may use the risk tolerances to filter for wager scenarios from a plurality of wager scenarios that are within this probability range after the plurality of wager scenarios are retrieved from a data structure. Alternatively, or additionally, some embodiments may detect a player has only selected wagers of a particular set of wager types and, as a result, the data processing system may further update either an LLM-generated query or the retrieved records of a query to select for wager scenarios of that set of wager types.

In some embodiments, a game parameter tolerance may be converted into another format before being used to search for a format. For example, some embodiments may receive a request to retrieve wager scenarios matching a particular odds value “40:20,” where an odds value may be a type of game parameter. Some embodiments may normalize the odds value to another odds value (2:1), a weight value (e.g., an inverse of the odds value), convert the odds value to a percentage value, or otherwise normalize the game parameter to a standardized scale that is stored in data structure of wager scenarios. Furthermore, some embodiments may change the odds value to a nearest stored value. For example, if a player enters a prompt requesting wagers having an odds value of “100.5:1,” some embodiments may change the odds value to “100:1” converting the odds value to a percentage, finding the closest percentage for which a wager scenario exists, and using the new odds value to augment the input context for an LLM prompt or filter a query result. It should be understood that, instead of using odds values, other metrics of probability may be used (e.g., a decimal probability, a weight value, etc.).

In some embodiments, a data processing system may a detect that a game parameter tolerance provided by a player or retrieved by the data processing system exceeds a game parameter tolerance setting. In response, some embodiments may either change the prompt-submitted tolerance to the game parameter tolerance setting or, alternatively, reject the prompt and prevent LLM use based on the submitted prompt. For example, as described elsewhere in this disclosure, a data processing system may perform one or more post-processing steps on an LLM output or the result of a search performed based on the LLM output. The data processing system may detect that an output query produced by the LLM includes instructions for a risk tolerance range and then apply a rules-based engine to determine if the risk tolerance range correctly indicates an existing loss that should modify the risk tolerance. For example, a player may provide the prompt “risk less than $10,000” to an LLM, and the LLM may produce a query that includes the query portion “loss<10,000.” However, a data processing system may use a rule-based system to retrieve data from a player indicating that an administrator-defined maximum risk threshold for the retrieved wager scenario is equal to $500 and, in response, modify the query portion to recite “loss<500.” Alternatively, some embodiments may simply reject the player-provided prompt entirely. In either case, the data processing system may cause a client device to present a text message, graphic, or other indication that the player had provided a tolerance value that exceeded the value of the game parameter tolerance setting. It should be understood that a game parameter tolerance may be or include other types of game parameters, such as a threshold odds value, a threshold weights value, a threshold expected loss, a threshold maximum loss amount, etc.

In some embodiments, a data processing system can generate an output message identifying a wager scenario that satisfies game parameter tolerance using a language model, a subset of wager scenarios, and the prompt (BLOCK 310). Some embodiments may further use an initial input context in combination with a search result to form a downstream response to a player-provided prompt. For example, a data processing system may augment the input context of a player-provided prompt using operations described in this disclosure (e.g., by including a set of event identifiers, a set of line values, a set of risk tolerances, a set of index identifiers) and provide the augmented prompt to an LLM. The LLM may then generate a query that can be used to retrieve the data from one or more indexed data structures, where the query may prompt a search through multiple indexes concurrently to retrieve both direct wager scenarios and alternative wager scenarios at an efficient rate.

In some embodiments, a data processing system may detect that a risk tolerance exceeds a pre-configured risk tolerance setting. For example, a player profile for a player may indicate a risk tolerance setting requiring that an odds value of a wager should not exceed −120. However, the player may either identify a wager scenario in the prompt that exceeds the risk tolerance setting stored in the player profile or explicitly set the risk tolerance setting for a search to be greater than the profile-stored threshold odds value. When generating an output message, some embodiments may generate the output message to include a text message indicating that the risk tolerance associated with an identified wager scenario or indicated in the prompt exceeds the value of the risk tolerance setting. Alternatively, or additionally, some embodiments may generate or modify an output message that includes a metadata tag such that an application interface will visually indicate that a risk tolerance setting is violated (e.g., via highlighting, changing the color of a text, generating a pop-up box, etc.).

Some embodiments may use a second machine learning model to process some or all of a set of player-provided data (e.g., image data, audio data, text data) that is then provided to an LLM as a prompt. For example, a data processing system may receive image data from a player and provide the image data to a convolutional neural network to extract a set of recognized text characters or set of recognized objects. Some embodiments may then use results of the convolutional neural network (e.g., recognized objects, recognized text, etc.) to augment the prompt of the LLM or an input context provided to the LLM in association with the prompt. In some cases, the recognized data may even be used to form part of a risk tolerance or other game parameter. For example, a data processing system may obtain a player-provided prompt that includes, “retrieve all wager scenarios having odds better than the win rate of the attached team” and an image of a sports team logo for the team “City State Dasypogons.” The data processing system may use a neural network to identify the sports team logo, map it to the sports time, and modify the original prompt to “retrieve all wager scenarios having odds better than the odds of the City State Dasypogons.” In some embodiments, a data processing system may then directly retrieve data related to the CityState Dasypogons and retrieve odds values associated with this team. Based on results provided by a machine learning model for the phrase “better than the odds of the CityState Dasypogons,” the data processing system may then set a maximum risk tolerance to be equal to that of the “CityState Dasypogons” as part of the input context for a prompt to an LLM.

Alternatively, or additionally, some embodiments may perform post-querying operations to filter a database search result to either remove or augment wager scenarios based on a risk tolerance or other game parameter. For example, a data processing system may remove a set of wager scenarios from a list of retrieved wager scenarios after determining that one or more of the retrieved wager scenarios indicate a risk value greater than a player-indicated risk tolerance or prompt-indicated risk tolerance.

In some embodiments, an index may be constructed based on bins or other groupings of game parameter tolerances instead of a single game parameter value. By maintaining an index or a part of an index based on game parameter range, index maintenance for multi-part indexes can be simplified for specific values (e.g., by updating game parameter tolerances without updating other elements of the index). Furthermore, in the case where a game parameter tolerance is ordered, the adjacency of different tolerance bins can be used to provide related game scenarios that may be of interest to a player. Some embodiments may identify a first ordered tolerance category from a series of tolerance categories based on the game parameter tolerance indicated in the prompt and use this data to select a subset of the plurality of wager scenarios. For example, a data processing system may obtain a prompt that includes a preferred tolerance range “12%” and, in response, select the tolerance category “10%≤risk_tolerance<12.5%.” Some embodiments may then search through a vector index of a database to retrieve a set of wager scenarios from the database by then searching through adjacent segments of a vector index, where the adjacency may be with respect to a specific vector direction corresponding with a game parameter tolerance category. For example, a data processing system may use the ordering of a series of ordered tolerance categories to retrieve wager scenarios. After searching for wager scenarios indexed in the first ordered tolerance category “10%≤risk_tolerance<12.5%” to obtain a first group of wager scenarios, the data processing system may search through wager scenarios in a second ordered tolerance category “8%≤risk tolerance<10%” to retrieve a second group of wager scenarios, where this second ordered tolerance category is adjacent to the first ordered tolerance category. By using the implicit ordering of a series of tolerance categories, some embodiments may increase the likelihood of retrieving a wager scenario of interest to a player.

In some embodiments, a data processing system can provide the output to a client device (BLOCK 312). As described elsewhere in this disclosure (e.g., operations for BLOCK 212), some embodiments may perform operations to provide an output message to a client device. For example, some embodiments may present retrieved wager scenario data in a pre-constructed UI template that identifies aspects of a wager scenario, such as an event name, an outcome for the event, and a set of numeric values characterizing the wager (e.g., odds of occurrence, payment, etc.). Alternatively, or additionally, some embodiments may provide previously retrieved data to an LLM in the form of an additional prompt and provide an output of the LLM to the player in a chat window. For example, after retrieving a list of available wager scenarios satisfying a set of risk tolerances, a data processing system may provide wager scenario data from the retrieved records to an LLM acting as a language summarization model to generate a summary of the wager scenarios and present the summary to a player via chat interface.

### D. Game Scenario Comparisons

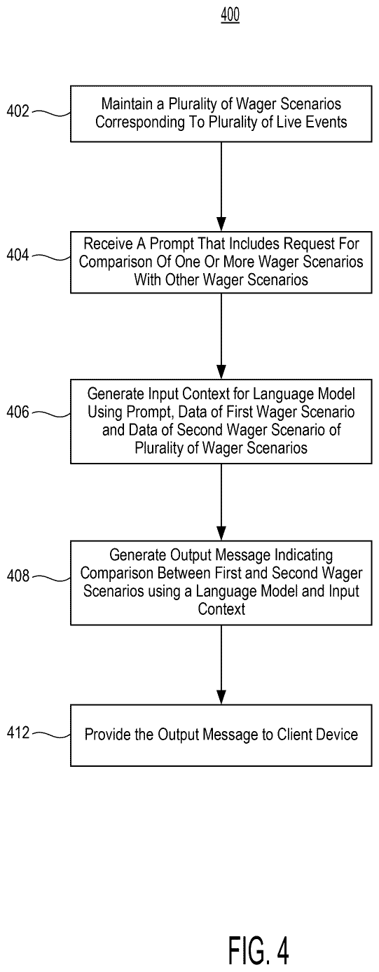

FIG. 4 illustrates an example flow diagram of a method for performing a game scenario comparison associated with live events based on a player-generated prompt, in accordance with one or more embodiments. The method 400 may be executed, performed, or otherwise carried out by an interactive server or a system. A data processing system (e.g., the data processing system 105) may be remote to one or more client systems (e.g., the client system 115) and one or more machine learning systems (e.g., the machine learning system 120) and can communicate with the one or more client systems or the one or more machine learning systems via a computer network (e.g., the network 110). In a brief overview of method 400, the interactive server or the system can maintain a plurality of wager scenarios corresponding to a plurality of live events (BLOCK 402), receive a prompt that includes a request for a comparison of one or more wager scenarios with other wager scenarios (BLOCK 404), generate an input context for a language model using the prompt, data of the first wager scenario and data of the second wager scenario of the plurality of wager scenarios (BLOCK 406), generate an output message indicating a comparison between the first and second wager scenarios using a language model and the input context (BLOCK 408), or provide the output message to a client device (BLOCK 412).

In some embodiments, a data processing system can maintain a plurality of wager opportunities corresponding to a plurality of live events (BLOCK 402). As described elsewhere in this disclosure (e.g., operations for BLOCK 202 or BLOCK 302), wager opportunities or other wager scenarios may be stored in one or more indexed data structures, where an indexed data structure may be indexed by a set of indexes that includes one or more vector indexes. Such indexes may be used to retrieve specific sets of data useful for comparison by indexing one or more specific fields of a wager scenario record or a parent record to help augment the input context for a large language model. In some embodiments, one or more indexes of the indexed data may be an index for a vector database in which at least a portion of the vector values indicate text descriptors or other textual information about a wager scenario or event related to the wager scenario. For example, some embodiments may index a vector database using a Hierarchical Navigable Small World (HNSW) indexing system to quickly search for other wager scenarios that may be linked to a first wager scenario via descriptions about the wager scenarios.

In some embodiments, a data processing system may maintain multiple indexes for an indexed data structure storing wager scenarios, where a first index indicates a probability value (e.g., an odds value, a weight value, a normalized probability), and where a second index is a vector index that is generated from a text description of an event. In many cases, basic term matching or pattern matching may be insufficient to quickly retrieve data for conceptually related wager scenarios. For example, a player may seek to compare an identified wager scenario with other wager scenarios in a different sport based on shared sentiments for a likelihood of victory. As described elsewhere in this disclosure, some embodiments may search a vector database for wager scenarios. In some embodiments, a data processing system may receive a request that explicitly or implicitly includes a request to search for wager scenarios based on a standard type of request, such as a request to retrieve wager scenarios for a same event that may differ with respect to odds values, point spread, totals, etc. The data processing system may search a wager scenario database for these values using one or more indexes based on these standard metrics.

In some embodiments, a request for a comparison with a first wager scenario may include wager scenarios that are associated with the first wager scenario in a non-standardized method that is not based on a quantified metric of wager scenarios. Some embodiments may account for these requests by using one or more vector database indexes relating to vectors representing the descriptors, other text data, or visual data associated with a wager. In some embodiments, a data processing system may then use these indexes to find similar wagers in a same region in the vector space of the vector database by (1) extracting a set of query parameters from a player-provided prompt or other player-provided input and (2) generating a database query using the set of query parameters. The data processing system may perform a nearest neighbor search using the generated query. For example, the data processing system may use an HNSW index to quickly find wager scenario records near a wager scenario record identified by the set of query parameters or retrieve wager scenario records. Some embodiments may use these nearest neighboring vectors and their corresponding records to retrieve a set of query parameters from the corresponding records.

In some embodiments, a data processing system can receive a prompt that includes a request for a comparison of one or more wager scenarios with other wager scenarios (BLOCK 404). As described elsewhere in this disclosure (e.g., operations described BLOCK 204 or BLOCK 304), the data processing system can receive a prompt via an application interface (e.g., a graphic interface displayed on a player's client device). The prompt may include a request for a comparison between different wager scenarios in text form. For example, a prompt may include the text “provide wager comparisons between the City State Dasypogons and the NationCity Pogondasys” to request a comparison between a first team identified as “CityState Dasypogons” and a second team identified as “NationCity Pogondasys.” Alternatively, or additionally, the prompt may include a graphic request for a comparison between different wager scenarios in other forms, such as via a player's selection of a team or event in a drop-down menu, radio dial, button, text entry field, etc.

In some embodiments, a data processing system may search an indexed data structure to retrieve candidate wagers and then select one or more wagers for comparison based on text data provided by the player. In some embodiments, a data processing system may search multiple indexes to retrieve different wager scenarios sorted by the multiple indexes. For example, some embodiments may use a first index that indexes wager scenarios based on line values to retrieve a first candidate wager scenario and a second index that sorts wager scenarios based on alternative bet odds value to retrieve a second candidate wager scenario.

Some embodiments may then compare text descriptors associated with each respective wager scenario to select which of the candidate wager scenarios to use for comparison purposes. For example, some embodiments may use an encoder model having an embedding matrix to convert the text descriptions for each wager scenario into sets of embedding representations. For example, a data processing system may provide, as inputs for an encoder model, a first text descriptor of a player-identified wager scenario, a first candidate wager scenario, and a second candidate wager scenario. In some embodiments, the encoder model may apply the embedding matrix to the text descriptors for the wager scenarios to generate a set of vectors as a set of embedding representations. Each respective set of embedding representations may correspond with a respective descriptor of the descriptors in an embedding space. In some embodiments, a text descriptor may be represented by a single vector acting as the set of embedding representations. Alternatively, or additionally, a text descriptor may be represented by a plurality of vectors acting as the set of embedding representations.

In some embodiments, the respective distance between respective pairs of vectors of the set of vectors may indicate similarities with respect to the descriptions for these wager scenarios. The distance between a pair of embedding representations may indicate a likelihood that two wagers are highly related. For example, a data processing system may perform a ranking of a first distance in vector space between the player-identified wager scenario and the first candidate wager scenario and a second distance in vector space between the player-identified wager scenario and the second candidate wager scenario. The data processing system may then select the candidate wager scenario that is least in distance with respect to the player-identified wager scenario. For example, a first distance between the player-identified wager scenario and the first wager scenario may be a minimum distance with respect to other distances between the player-identified wager scenario and other candidate wager scenarios detected using operations described in this disclosure. In response, a data processing system may select the first candidate wager scenario for comparison operations described in this disclosure.

In some embodiments, a player may directly identify an alternative wager scenario for comparison with a first wager scenario. Some embodiments may determine whether this alternative wager scenario is stored in a data structure and, if so, update an index to indicate an association between the alternative wager scenario and the first wager scenario. For example, a data processing system may receive a request to compare a first wager scenario with the second wager scenario, where the first and second wager scenarios are for different events. Some embodiments may update one or more indexes to reflect this player-created association between different wager scenarios. Furthermore, in some embodiments, a data processing system may require a threshold number of associations between wager scenarios from different players before updating the one or more indexes. For example, a data processing system may obtain a first prompt from a player requesting a comparison between a first and second wager scenario. The data processing system may determine whether this comparison request has been made by at least five other players. In response to a result indicating that this threshold of at least five players is satisfied, the data processing system may update an index of alternative wager scenarios to associate the first wager scenario with the second wager scenario. By updating an index to include player-provided associations between a first wager scenario with one or more alternative wager scenarios, a data processing system may increase the likelihood that other players will find non-conventional associations between wagers in real time.

In some embodiments, a data processing system can generate input context for a language model to provide by using the prompt, data associated with the first wager scenario, and data associated with a second wager scenario (BLOCK 406). As described elsewhere in this disclosure, some embodiments may maintain a data structure that is indexed by odds values, weight values, or other probability-related values for wager scenarios. For example, a data structure may be indexed by various odds values, such as a first odds value equal to “10:1,” a second odds value equal to “1:1,” etc. Alternatively, or additionally, some embodiments may maintain an index of events or wager scenarios that indicates one or more odds values corresponding with that wager scenario or event. In some embodiments, a data processing system may receive a request for comparison that involves retrieving data for wager scenarios based on these odds values. For example, after using operations described in this disclosure to obtain a first wager scenario for comparison with a second wager scenario, a data processing system may retrieve, via a wager scenario index, a first odds value for the first wager scenario and a second odds value for the second wager scenario. Furthermore, various other types of information, such as historical wager scenarios selected by the player or data derived from historical wager scenarios, may be included in the input context.

In some embodiments, a selection between multiple candidate wager scenarios for comparison may be based in part on a game parameter tolerance that is set by a player's profile, set by a system setting, set by a player's instructions via a prompt, etc. For example, a data processing system may receive, via a player-provided prompt, an indication of a player's risk tolerance. Some embodiments may then filter one or more candidate wager scenarios based on the indicated risk tolerance such that one or more odds value, line value, or other wager metric exceeds the indicated risk tolerance.

Alternatively, after determining that a wager scenario would not satisfy or other game parameter tolerance, a data processing system may form a set of second wager scenarios that would satisfy the risk tolerance or other game parameter tolerance. A data processing system may generate this set of second wager scenarios by changing one or more wager properties to satisfy the risk tolerance or other game parameter tolerance. For example, a data processing system may determine that a candidate wager scenario exceeds a risk tolerance with respect to a line value instead of filtering out the candidate wager scenario from a comparison or other operations, and the data processing system may modify the line value or other wager properties of this second candidate wager to satisfy the risk tolerance. The data processing system may then use the modified version of this wager scenario as part of a set of second wager scenarios when preparing an input context, where the input context may include the modified wager property or other properties of this set of second wager scenarios.

In some embodiments, a data processing system may generate one or more documents indicating data related to selected wager scenarios. For example, a data processing system may generate a first document that indicates data characterizing a player-identified wager scenario, where such data may include a wager type of the wager scenario (e.g., an indication that the wager type is “straight bet,” “parlay,” etc.). The data processing system may also generate a document that includes data characterizing a candidate wager scenario or dynamically generated wager scenario. Alternatively, or in addition, a data processing system may generate summaries of wager scenarios (e.g., by providing an input context and prompt to a machine learning summarization model) so that a player or downstream subsystem may more easily understand the essential characteristics of a wager scenario. For example, the data processing system may generate a first summary based on data characterizing a player-identified wager scenario, a summary based on data characterizing a candidate wager scenario, or a summary based on a dynamically generated wager scenario. By using separate documents, a downstream process may more easily retrieve a wager scenario. Furthermore, storage of a document that includes data related to a dynamically generated wager scenario may help to reduce the need to re-create the dynamically generated wager scenario in future operations. In some embodiments, a data processing system may store some or all of the documents generated to include wager scenario data in storage memory for later use.

In some embodiments, a data processing system may generate the set of second wager scenarios by updating an initial wager scenario provided by or otherwise identified by a player. For example, a player may provide a prompt requesting a comparison between a first wager scenario and other wager scenarios, where the requested other wager scenarios may be dependent on the first wager scenario and the satisfaction or failure of one or more additional conditional events. For example, a requested wager scenario may include all of the outcomes listed in an original wager scenario that requires that a first team win a game and a condition that the first team identified score in overtime. In some embodiments, a data processing system may account for such modifications as additional wager scenarios by using an index that is organized in part by additional conditional events. For example, a data processing system may search a data structure of wager scenarios by using an index that includes both a set of additional conditional events and live event identifiers.

In some embodiments, a data processing system can generate an output message indicating a comparison between the first and second wager scenarios using a language model and the input context (BLOCK 408). As described elsewhere in this disclosure (e.g., BLOCK 210 or BLOCK 308), a data processing system can use an LLM to generate an output message based on a player prompt and an input context. In some embodiments, the data for each respective comparison of a set of comparisons may be individually provided to an LLM. For example, initial data for an initial wager scenario may be collected in an initial JSON object, first candidate data for a first candidate wager scenario may be collected in a first JSON object, and second candidate data for a second candidate wager scenario may be collected in a second JSON object. A data processing system may provide an input context that includes the initial JSON object and the first JSON object to generate a first output that compares the initial wager scenario with the first candidate wager scenario. The data processing system may then provide an input context that includes the initial JSON object and the second JSON object to generate a second output that compares the initial wager scenario with the second candidate wager scenario. Alternatively, a data processing system may provide all, in a single input context, the initial, first, and second JSON objects to an LLM to generate first comparison data and second comparison data.

In some embodiments, a client system or a data processing system may perform operations to change text commands into command characters. A command character may include slash characters (e.g., “/change”, “/help”, etc.) or symbolic characters (e.g., “#”, “#new”, “! #˜”, etc.). Furthermore, in some embodiments, a player may directly enter command characters into a text field of an interface. Additionally, or alternatively, a prompt-generating language model, such as a query-building language model, may output a command character that prompts downstream updates to player-related data or system-related data. For example, a data processing system may receive a prompt that includes text instructions to update a player profile from the player (e.g., reselect a second wager scenario in view of a first wager scenario after seeing the second wager scenario compared to the first wager scenario). In response, the data processing system may provide the prompt and associated input context to an LLM, where the LLM may then output one or more command characters that causes a downstream operation to update the player profile to identify or otherwise indicate the second wager scenario.

In some embodiments, a player that views a comparison between a first wager scenario and a second wager scenario may choose to change a previous selection of the first wager scenario to a selection of the second wager scenario. For example, a data processing system may receive from a player, via a client device, a first request to generate a comparison between a first wager scenario and one or more second wager scenarios. After the data processing system performs operations described in this disclosure to display a comparison between the first wager scenario and a set of second wager scenarios, some embodiments may receive a second request from the player. The second request may indicate a selection of one or more scenarios of the set of second wager scenarios in the lieu of the first wager scenario. In response to receiving this second request, the data processing system may update a player profile for the player to identify or otherwise indicate this selected subset of second wager scenarios. In cases where the data processing system uses an in-memory data store to increase the speed of data retrieval for real-time applications, the data processing system may store data characterizing the replacement scenario in the in-memory data store. For example, after receiving a request to replace a straight bet having a line value equal to “10” with a straight bet having a line value equal to “5,” a data processing system may update a Redis data store to include properties of the second straight bet.

In some embodiments, a data processing system can provide the output message to a client device (BLOCK 412). As described elsewhere in this disclosure (e.g., operations for BLOCK 212 or BLOCK 412), some embodiments may perform operations to provide an output message to a client device. Some embodiments may present a comparison of wager scenarios as a side-by-side comparison of features. Furthermore, a presented output message may visually indicate differences between different wager scenarios. For example, a client device may highlight differences in wager scenarios, generate a summary of wager scenario differences, etc.

### E. Example Application Interfaces

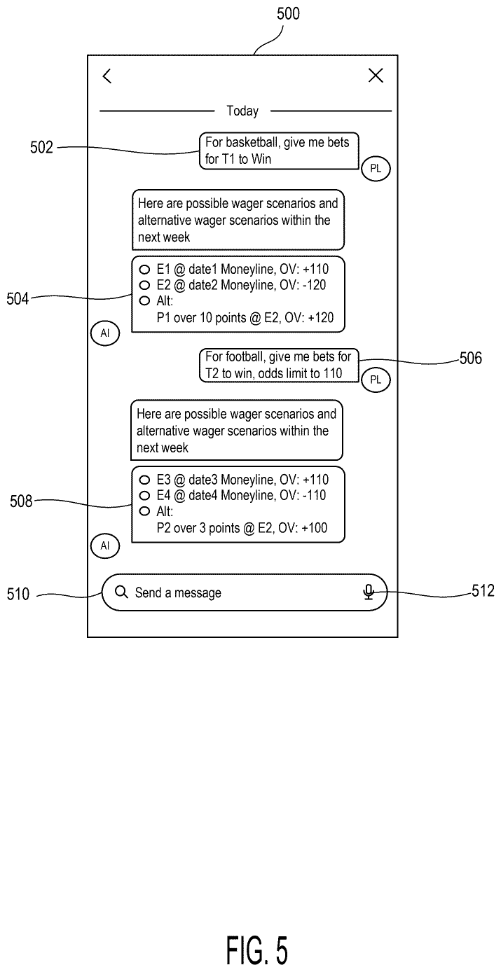

FIG. 5 illustrates an example implementation of an application interface to retrieve wager scenario recommendations and to limit wager scenario searches based on a game parameter tolerance, in accordance with one or more implementations. As shown, a graphical user interface 500 can display a first prompt field 502 based on a player's interaction with a message bar 510. The first prompt field 502 can be an initial prompt or search term entered by the player via the message bar 510. The message bar 510 can be used to input text or initiate voice commands for sending the first prompt field 502 or other prompts. For example, players can type their message directly into the designated text box within the message bar 510, or they can use a microphone icon 512 to dictate their prompts. In this example, the first prompt field 502 recites, “For basketball, give me bets for T1 to Win,” indicating the player's interest in viewing wager recommendations in the context of baseball.

In some embodiments, the data processing system 105 can receive the first prompt field 502 from the client system 115 over the network 110. The data processing system 105 can determine the classification of the request included in the first prompt field 502, such as classifying the prompt in the first prompt field 502 as a request for wagers instead as a request for information. The data processing system 105 may also identify other information, such as the desired wager type and relevant player or team. The data processing system 105 can generate an input context using a first model of the set of language models 190, such by using a query-building language model as described for one or more methods described in this disclosure. For example, the data processing system 105 can parse the first prompt field 502 to obtain the intents “basketball” and “T1 to win,” where the data processing system 105 may determine that these words or phrases are intents based on rules-based matching subsystem. For example, some embodiments may use a rules-based matching subsystem that that breaks a text string into one or regular expression patterns and matches the resulting patterns with a data set of known intents). In some embodiments, the data processing system 105 may then use these intents as inputs to a query-building language model to retrieve a set of wager scenarios using multiple indexes to retrieve wager scenarios directly corresponding with the request and alternative wager scenarios directed by an index. For example, the data processing system 105 may access a first index that retrieves data directly based on the request for wagers satisfying the intent “T1 to Win” and “basketball wagers” to retrieve a first event “E1” and a second event “E2.” Additionally, the data processing system 105 may access a second vector index that links alternative wagers to initial wagers. Based on the data retrieved via the second vector index, the data processing system 105 may retrieve the alternative wager “P1 over 10 points.” The data processing system 105 may then generate a first input context that includes wager properties for “E1,” “E2,” and “P1 over 10 points.”

In some embodiments, an LLM of the set of language models 190 can process the first prompt field 502 and the first input context to generate an output message that can then be provided to a client device. In some embodiments, the first input context may include data retrieved from records of retrieved wager scenarios, and the output message may include structured data of one or more of these retrieved wager scenarios. For example, the data processing system 105 may provide the LLM with the first prompt field 502 and the first input context to generate an output message that includes structured data, where the structured data includes wager-related information such as the wager type, wager participants, wager properties, etc. The client system 115 can display some or all of the output message by either directly outputting a text message of the output message or parsing data in the output message to display wager-relevant information. For example, the client system 115 may display a first list of possible wagers 504 based on wager scenario data provided in an input context retrieved from a database of wager opportunities. The first list of possible wagers 504 may indicate, for each respective wager scenario, an event identifier (e.g., “E1,” “E2,” or “P1 over 10 points”), an event date (e.g., “date1” or “date2”), a wager type (e.g., “Moneyline”), and an odds value (e.g., “+110,”“−110,” or “+120”).

In some embodiments, a model of the set of language models 190 can process a second prompt field 506 that includes a request for a wager and indicates a risk tolerance “−120.” Some embodiments may perform operations described in this disclosure to retrieve a set of wager scenarios limited by the risk tolerance and generate or update an input context based on the retrieved set of wager scenarios. For example, some embodiments may provide the second prompt field 506 to a query-building language model to generate a query that limits a risk tolerance by “110,” which may indicate a risk tolerance for wagers having odds values that are at most “+120” or “−120.” In some embodiments, the data processing system 105 may provide the second prompt field 506 to a query-building model of the set of language models 190 to generate a query for additional queries. The data processing system 105 may then retrieve, based on the query, data for a second set of wager scenarios labeled as “E3,” “E4,” and “P2 over 3 points” and include this data in a second input context. After generating this second input context, the data processing system 105 may provide the second prompt field 506 and the second input context to an LLM of the set of language models 190 to generate an output message that is then presented by the client system 115 for display.

For example, the structured data in the output message may include wager-related information such as the wager type, wager participants, wager properties, etc. The client system 115 can display some or all of the output message by either directly outputting a text message of the output message or parsing data in the output message to display wager-relevant information. For example, the client system 115 may display a second list of possible wagers 508 based on wager scenario data provided in an input context retrieved from a database of wager opportunities.

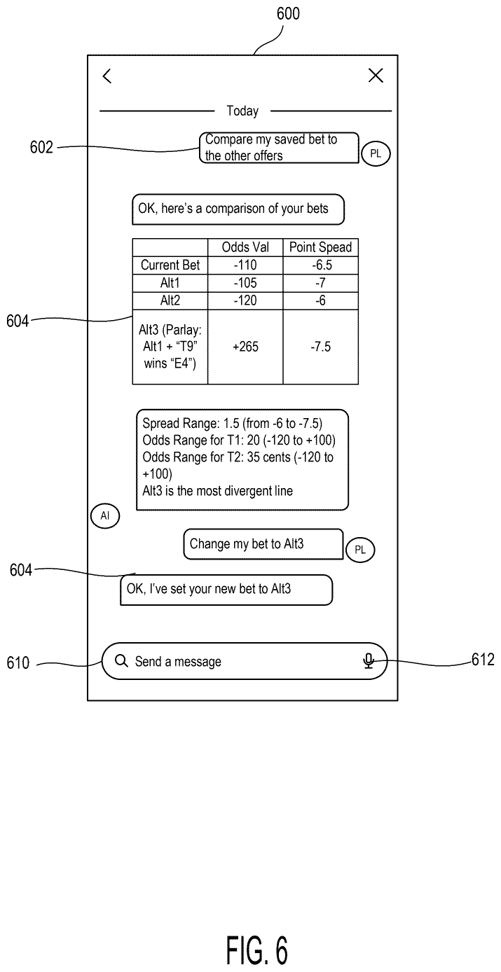

FIG. 6 illustrates an example implementation of an application interface to retrieve wager scenario comparisons, in accordance with one or more implementations. As shown, a graphical user interface 600 can be presented by the client system 115 and can display a first prompt field 602 based on a player's interaction with a message bar 610. The first prompt field 602 can be an initial prompt or search term entered by the player via the message bar 610. The message bar 610 can be used to input text or initiate voice commands for sending the first prompt field 602 or other prompts. For example, players can type their message directly into the designated text box within the message bar 610, or they can use a microphone icon 612 to dictate their prompts. In this example, the first prompt field 602 recites, “compare my saved bet to other comparative offers,” indicating the player's interest in viewing wager comparisons.

The data processing system 105 may receive the first prompt field 602 and also retrieve player data from a player profile indicated by the client system 115. The data processing system 105 may provide wager-related data indicating a selected wager scenario and provide the first prompt field 602 to a query-building language model of the set of language models 190. The query-building model may then retrieve data for a set of wagers indicated to be comparable using methods described in this disclosure (e.g., operations described for the method 400). For example, the data processing system 105 may select one or more additional wager scenarios based on a determination that the first prompt field 602 includes a request for a comparison based on shared events between properties. In some embodiments, the data processing system 105 may use multiple indexes to increase the likelihood of accurate real-time data retrieval, such as by retrieving comparison wagers for both direct bets and alternative bets. For example, the data processing system 105 may retrieve a first wager scenario “Alt1” and second wager scenario “Alt2” using a first index for direct bets. The data processing system 105 may retrieve a third wager scenario “Alt3” using an alternative index for alternative bets with respect to the current bet.

### F. Computing nd Network Environment

In some embodiments, a client system, such as the client system 115, can include at least one processor and a memory, e.g., a processing circuit. The memory can store processor-executable instructions that, when executed by the processor, cause the processor to perform one or more of the operations described herein. The processor can include a microprocessor, an ASIC, an FPGA, etc., or combinations thereof. The memory can include, but is not limited to, electronic, optical, magnetic, or any other storage or transmission device capable of providing the processor with program instructions. The memory can further include a floppy disk, CD-ROM, DVD, magnetic disk, memory chip, ASIC, FPGA, ROM, RAM, EEPROM, EPROM, flash memory, optical media, or any other suitable memory from which the processor can read instructions. The instructions can include code from any suitable computer programming language.

In some embodiments, a data processing system, such as the data processing system 105, can include a cloud system, a server, a distributed remote system, or any combination thereof. The data processing system can include a virtual computing system, an operating system, and a communication bus to effect communication and processing. The data processing system can include physical infrastructure, such as physical servers, storage devices, and network equipment housed in data centers. The data processing system can include a virtual computing system, which can include cloud-based virtual machines or containers for running applications and services.

The data processing system can include an operating system that can function as the core manager, orchestrating applications and services, allocating resources, configuring processes, and maintaining seamless interaction between hardware and applications. The data processing system can include a communication bus that can facilitate communication between different components within the system. The data processing system can connect with external systems to allow for data exchange and service delivery to end users.

In some embodiments, a client system, such as the client system 115, can include one or more devices to receive input from a player or to provide output to a player. For example, the output capabilities of the application interface 185 may be presented by a display device that provides visual feedback to the player. The display device can enhance the player experience with electronic displays, such as liquid crystal displays (LCD), light-emitting diode (LED) displays, or organic light-emitting diode (OLED) displays. The electronic displays can implement interactive features, including capacitive or resistive touch input, allowing for multi-touch functionality. The input functionalities can include a keyboard, mouse, or an integrated touch-sensitive panel on the display device but are not limited thereto.

In some embodiments, a communication session may be indicated by a series of prompts and responses exchanged between the player and the data processing system. For example, upon a player interaction with an interactive element presented by an application, such as clicking a button or entering text, a prompt may be generated and added to the conversation record associated with the session. The data processing system can process the prompt and generate a corresponding response, which may be appended to the conversation record. In some embodiments, the data processing system can establish a communication session with the client device using various protocols, such as HTTP, WebSocket, or other network-based communication methods. The connection can allow for the exchange of data and messages. The data processing system can identify or record the specific client device engaged in the communication session, as described herein.

In some embodiments, memory storage, such as the storage 125, can store multiple sets (e.g., a plurality) of formatting instructions, which may be generated in part based on output from a model of the set of language models 190. In some embodiments, each set of formatting instructions can correspond to a respective type of wager opportunity (e.g., moneyline, parlay, etc.). The formatting instructions can include instructions to present different graphical elements corresponding to different attributes or properties of wager opportunities, such as the set of wager scenarios 160. The content/arrangement of the wager opportunities may depend on, or be a function of, the type of the wager opportunity for which the formatting instructions are provided. For example, the formatting instructions can include display instructions. The display instructions can cause the presentation of the wager opportunities on an application interface, such as the application interface 185. The display instructions can include JavaScript, Hypertext Markup Language 5 (HTML5) data, or other types of display instructions. The formatting instructions can specify elements such as text formatting, layout, and the inclusion of visual components or graphical assets, among others.

Formatting instructions can include instructions for presenting interactive elements, such as buttons or links associated with wager opportunities (e.g., to place the wager, navigate to a specification application, access specific functionalities, etc.). In some embodiments, the formatting instructions can include instructions and/or indications to retrieve information from one or more network locations. For example, the formatting instructions can include one or more identifiers for one or more network locations of graphical/audio/video assets or information relating to one or more wager opportunities. These identifiers can indicate a web address or other reference point that a data processing system, a client system, or a machine learning system can use to retrieve relevant information regarding the wager (e.g., retrieving the latest odds for a particular wager opportunity). The formatting instructions can indicate a graphical layout location (e.g., relative or absolute location) that may be used for instances where multiple content items representing wager opportunities are displayed on an application interface. For instance, the layout information can specify the order or location in which a particular wager opportunity is to appear (e.g., sorting in chronological order, relevance to an ongoing contest, ranking by priority, etc.).

In some embodiments, the data used for processing wager opportunities and the data used to generate an application interface (e.g., the application interface 185) may be structured differently. This separation can allow for flexibility in data management and presentation. For example, for parlay wager opportunities, the formatting instructions can include presentation/layout instructions to present multiple legs of the wager in one or more content items. Such formatting instructions can include instructions for hierarchical layouts or graphical elements, in some embodiments. In some embodiments, the formatting instructions can incorporate interactive elements such as buttons or links that, when clicked or interacted with, automatically cause the application presenting the interactive elements to transmit requests to place one or more wagers corresponding to the wager opportunities associated with the formatting instructions. The formatting instructions can include information about where to extract real-time odds for the wager, allowing dynamic updates of the wager details.

A machine learning system, such as the machine learning system 120, can include one or more machine learning models trained on various datasets, including but not limited to datasets for large language models. The machine learning system 120 can include a cloud system, one or more servers, a distributed remote system, or any combination thereof. The machine learning system 120 can include processing components that include, but are not limited to, one or more central processing units (CPUs), one or more graphics processing unit (GPUs), tensor processing units (TPUs), or the like. The machine learning system 120 can include a memory operable to store one or more instructions for operating components of the machine learning system 120 and operating components operably coupled to the machine learning system 120. For example, the instructions can include firmware, software, hardware, operating systems, or embedded operating systems, among others. The machine learning system 120 may be internal to the data processing system 105. For example, although shown as separate from the data processing system 105, in some embodiments the machine learning system 120 (or the functionality thereof) may be implemented as part of the data processing system. In some embodiments, the machine learning system 120 may be external to the data processing system 105 and may be accessed via the network 110, for example, using one or more API keys or authentication processes to process input contexts and/or prompts from the data processing system 105. In some embodiments, the machine learning system 120 may implement or otherwise provide access to one or more application programming interfaces (APIs), via which the data processing system 105 and/or the client system 115 can access a model of the set of language models 190 or other functionality of the machine learning system 120.

A network, such as the network 110, can include computer networks such as the Internet, local, wide, metro, or other area networks, intranets, satellite networks, other computer networks such as voice or data mobile phone communication networks, and combinations thereof. The network may be any form of computer network that can relay information between different computer devices. For example, the network 110 may be any form of computer network that can relay information between the data processing system 105, the client system 115, the machine learning system 120, and one or more information sources, such as web servers or external databases, amongst others. The network can include the Internet and/or other types of data networks, such as a local area network (LAN), a wide area network (WAN), a cellular network, a satellite network, or other types of data networks. The network 110 can include any number of computing devices (e.g., computers, servers, routers, network switches, etc.) that are configured to receive and/or transmit data within the network. The network can further include any number of hardwired and/or wireless connections. Any or all of the computing devices described herein (e.g., the data processing system 105, the client system 115, the machine learning system 120, etc.) can communicate wirelessly (e.g., via Wi-Fi, cellular, radio, etc.) with a transceiver that is hardwired (e.g., via a fiber optic cable, a CAT5 cable, etc.) to other computing devices in the network. Any or all of the computing devices described herein can communicate wirelessly with the computing devices of the network via a proxy device (e.g., a router, network switch, or gateway).

A data processing system may include non-transitory memory (e.g., storage) or other non-transitory, machine-readable media. For example, the data processing system 105 is shown as including the storage 125. Storage or other non-transitory, machine-readable media may be a computer-readable memory that can store or maintain any of the information described herein. In some embodiments, the non-transitory, machine-readable media can store data associated with a computer system described in this disclosure, such as the system 100. The storage can include one or more hardware memory devices to store binary data, digital data, or the like. The storage can include one or more electrical components, electronic components, programmable electronic components, reprogrammable electronic components, integrated circuits, semiconductor devices, flip flops, arithmetic units, or the like. The storage can include at least one of a non-volatile memory device, a solid-state memory device, a flash memory device, or a NAND memory device. The storage can include one or more addressable memory regions disposed on one or more physical memory arrays. A physical memory array can include a NAND gate array disposed on, for example, at least one of a particular semiconductor device, an integrated circuit device, or a printed circuit board device. In an aspect, the storage can correspond to a non-transitory computer readable medium. In an aspect, the non-transitory computer readable medium can include one or more instructions executable by the system processor 130.

A storage, such as the storage 125, can store/maintain one or more data structures, which can include containers, indexes, or otherwise store each of the values, pluralities, sets, variables, vectors, numbers, or thresholds described herein. In some embodiments, the storage can store, modify, or otherwise maintain any of the information described herein using one or more databases. Storage may be accessed using one or more memory addresses, index values, or identifiers of any item, structure, or region maintained in the storage. For example, the storage 125 may be accessed by the components of the data processing system 105, the client system 115, the machine learning system 120, or any other computing device described herein, via the network 110. In some embodiments, storage may be internal to the data processing system. For example, the storage 125 may be internal to the data processing system 105. Alternatively, storage can exist external to a data processing system and may be accessed via a network. For example, the storage 125 may be distributed across many different computer systems (e.g., a cloud computing system) or storage elements and may be accessed via the network 110 or a suitable computer bus interface.

Content items, such as an item of the set of content items 175, may be visual or graphical elements used within the application. For example, a content item can include an image, such as a preview, icon, or other visual representations associated with specific application interfaces. A content item can include an interactive element, which may be a button, link, or any clickable component. When a player interacts with the interactive elements (e.g., select, click-on, touch, hover), the interaction can trigger navigation within the application running on the client system 115. A content item can provide attributes for the corresponding application interface. A content item can include an event identifier (ID), which may be an identifier for a specific event within the application. In some embodiments, a content item can include, but is not limited to, creator ID, sport type, bet limits, odds limits, event status, expiration time, or event information, among other attributes/properties/characteristics. An event may be referred to as any sporting or competitive activity that functions as the basis for wagering. In some embodiments, an event may refer to any video or broadcast stream for which wagers may be provided. In some embodiments, events can refer to specific moments within a live sporting event upon which wagers may be placed (e.g., events for which live betting can occur). The event can include specific sporting events, tournaments, brackets, or other any activity or outcome on which wager(s) may be placed, including but not limited to individual contests between teams or players. The event can include entire competitions with multiple live events.

As described elsewhere in this disclosure, a data processing system, such as the data processing system 105, may include a system processor, such as the system processor 130. The system processor 130 can execute one or more instructions associated with the data processing system. The system processor can include an electronic processor, an integrated circuit, or the like, including one or more of digital logic, analog logic, digital sensors, analog sensors, communication buses, volatile memory, nonvolatile memory, and the like. The system processor can include, but is not limited to, at least one central processing unit (CPU), graphics processing unit (GPU), physics processing unit (PPU), tensor processing unit (TPU), embedded controller (EC), or the like. The system processor can include a memory operable to store or storing one or more instructions for operating components of the system processor and operating components operably coupled to the system processor. For example, the one or more instructions can include one or more of firmware, software, hardware, operating systems, or embedded operating systems. The system processor or the data processing system can include one or more communication bus controllers to effect communication between the system processor and the other elements of the data processing system.

The subsystems described in this disclosure may include hardware, software, or any combination thereof. For example, a subsystem may include any combination of hardware circuitry and software (e.g., script, file, program, application, set of program instructions, or other computer-executable code). For example, an intent classifier subsystem, such as the intent classifier subsystem 155, may be or include any script, file, program, application, set of instructions, or computer-executable code that is configured to determine the classification of the request included in a player input, referred to as a prompt.

Some embodiments may use a prompt receiver subsystem, such as the prompt receiver subsystem 135. A prompt receiver subsystem may be or include any script, file, program, application, set of instructions, or computer-executable code that is configured to process input data in the form of a prompt. A prompt can include any player-provided command, request, or text data. The prompt can include a request or information relating to bet placement, such as an indication of a wager type, a wager amount, or selecting specific live events or outcomes. The prompt receiver subsystem can receive the prompt from a client system in natural language (e.g., a text string). The prompt receiver subsystem can receive prompts through player interactions with an application interface, such as the application interface 185. Player interactions can include clicking buttons, entering text, or using voice commands within one or more application interfaces, among others. In some embodiments, the prompt receiver subsystem can expose an API endpoint, allowing other applications or systems to send prompts in structured formats such as JavaScript Object Notation (JSON) or XML. In some embodiments, the prompt receiver subsystem can subscribe to a message queue where prompts are published by other components/devices of the computer system. In some embodiments, the prompt receiver subsystem can identify specific events or triggers, such as player actions or system state changes, which can generate prompts. In some embodiments, the prompt receiver subsystem can process prompts loaded from files stored on a data processing system.

Some embodiments may use a device communicator subsystem, such as the device communicator subsystem 140. A device communicator subsystem may be or include any script, file, program, application, set of instructions, or computer-executable code that is configured to facilitate communication between a data processing system, a client system, or a machine learning system. The device communicator subsystem can facilitate communication between a data processing system, a network, a client system, or the machine learning system 120 via one or more communication interfaces. A communication interface can include, for example, an API compatible with components of the data processing system 105, the client system 115, or the machine learning system 120. Furthermore, a device communicator subsystem can support various communication protocols (TCP/IP, UDP) compatible with a particular component of a data processing system described in this disclosure. The device communicator subsystem can implement multiple communication interfaces, including web sockets or messaging protocols, to accommodate a range of client applications. The device communicator subsystem can facilitate data transfer through techniques such as compression, encryption, and error correction, among others.

A device communicator subsystem within a client system may be similar to, and include any of the structure and functionality of, a device communicator subsystem described in connection with a data processing system (e.g., the device communicator subsystem 140). For example, the client communicator subsystem within the client system can communicate with the data processing system or a machine learning system via a network using one or more communication interfaces to carry out the various operations described herein. The client communicator subsystem may be compatible with particular content objects and may be compatible with particular content delivery systems corresponding to particular content objects, structures of data, types of data, or any combination thereof.

A data processing system can include a model updater subsystem, such as the model updater subsystem 145. The model updater subsystem can train, fine-tune, update, re-train, or otherwise maintain one or more machine learning models (e.g., a model of the set of language models 190, etc.). The model updater subsystem can use various machine learning algorithms, including supervised learning techniques, to train/fine-tune/update one or more machine-learning models using labeled data (e.g., a subset of the set of training data 180) to improve their prediction accuracy or classification capabilities. In some embodiments, the model updater subsystem can implement unsupervised learning techniques, such as clustering and association rule mining, to identify patterns in unlabeled data, and/or to generate labels for said unlabeled data. The model updater subsystem can implement reinforcement learning techniques to update a language model based on player-provided feedback or examples in one or more training datasets.

A model updater subsystem, such as the model updater subsystem 145, can train/update/fine-tune a language model (e.g., a model of the set of language models 190) or other machine learning components to generate text formats, make recommendations, understand player intents, and personalize the player experience based on the training dataset. The model updater subsystem can implement various machine learning techniques, including supervised, unsupervised, and reinforcement learning, to continuously improve the performance of one or more models of the set of language models 190. In some embodiments, the model updater subsystem can provide instructions, training examples (e.g., from the set of training data 180, etc.) to the machine learning system 120, to cause the machine learning system 120 to train/fine-tune/update the set of language models 190 according to the techniques described herein. In some embodiments, training/updating/fine-tuning a model of the set of language models 190 can involve periodic retraining using updated datasets, incorporating additional linguistic data, and refining model parameters based on performance metrics, among others.

In some embodiments, the model updater subsystem can use Low-Rank Adaptation (LoRA), Quantized Low-Rank Adaptation (QLoRA), or other adapters to train/update/fine-tune a model of the set of language models 190. The model updater subsystem can use LoRA to address the challenge of fine-tuning large models without updating all parameters. For example, instead of fine-tuning all the weights in the model, the model updater subsystem can inject trainable low-rank matrices into each layer of the transformer architecture to reduce the number of trainable parameters or the computational load. In some embodiments, the model updater subsystem can extend LoRA by incorporating quantization techniques through QLoRA. For example, the model updater subsystem can combine quantization with low-rank adaptation to reduce computational load. In some embodiments, the model updater subsystem can use prefix tuning, which adds trainable vectors to the input sequence to guide the model's attention. In some embodiments, the model updater subsystem can use p-tuning, which uses continuous prompts to fine-tune the model. In some embodiments, the model updater subsystem can use LongLoRA, a variant of LoRA, to manage longer sequences.

In some embodiments, based on a prompt or player intent, one or more models of the set of language models 190 can receive input contexts from the data processing system 105 in various formats, such as text, JSON, or structured data. A model of the set of language models 190 can process the input context to determine a desired output or action. In some embodiments, a model of the set of language models 190 can generate a data structure defining a graphical element, including properties such as type (button, menu, image), content, layout, and interactive behaviors, among others. In some embodiments, the data structure can include metadata specifying a target application interface to be navigated to upon interaction with the graphical element. For example, the metadata may specify that the application interface 185 is the target application interface. The client system 115 can parse the received data structure and present the corresponding graphical element via the application interface 185.

In some embodiments, a data processing system, via a prompt receiver subsystem or an intent classifier subsystem, can extract relevant keywords or metadata from content items to facilitate content discovery, for example, through search functionalities. When a player initiates a search via the application interface, the data processing system can process the prompt and retrieve the relevant content item by matching keywords, embeddings, or other data extracted/generated from the prompt with corresponding keywords, embeddings, or other data stored with the content item. The intent classifier subsystem can generate an input context for a language model. The data processing system can transmit the input context to the language model, which can generate data structures corresponding to the content items.

As described elsewhere in this disclosure, a client system (e.g., the client system 115) can execute an application that communicates with a data processing system. The application can present one or more application interfaces, such as an application interface 185. The application interface 185 can include a set of rules or protocols that allow different software programs or systems to communicate with each other. The application interface 185 can provide user interfaces to facilitate interaction. Players can input information, view content, or initiate actions through the application interface 185. In some embodiments, the application interface 185 may be associated with a particular client application that communicates with the data processing system 105. The client application can include an application executing on each client system 115. The client application can include a web application, a server application, a resource, a desktop, or a file. In some embodiments, the client application can include a local application (e.g., local to a client system 115), a hosted application, a software-as-a-service (Saas) application, a virtual application, a mobile application, and other forms of content. In some embodiments, the client application can include or correspond to applications provided by remote servers or third-party servers.

A language model can determine one or more properties of an input that correspond to natural language. Natural language input can have a syntactic structure in which individual words, collections of words (e.g., phrases), or relative positions of words (e.g., word order) can indicate specific meanings. The language model may be trained/updated/fine-tuned to parse sentences into their grammatical components to understand the structure and relationships between words. The language model can use phrasing structure rules that define how words combine to form phrases and sentences. In some embodiments, the language model may be trained/updated/fine-tuned to transform sentence structures into more complex ones, such as turning a statement into a question, which can include a transformation that the language model can execute to enhance understanding and generate varied outputs.

The language model can receive an input context generated via an intent subsystem, such as the intent classifier subsystem 155. As described herein, the input context can include relevant wager opportunities (e.g., a relevant subset of the set of wager scenarios 160) identified based on the prompt. A data processing system can transmit the input context to the language model. A machine learning system can execute the language model to process the input context. The language model can generate a data structure including one or more tokens indicative of the syntactic meaning of a portion of the input context. For example, the language model can tokenize the input context to identify one or more named entities or the document, and one or more syntactic relationships between portions of the input context (e.g., adjectives, verb modifiers). In some embodiments, the token can indicate the beginning of specific formatting instructions. For example, the token can function as a marker, indicating where the instructions for displaying the generated content start.

In some embodiments, a data processing system can perform data acquisition to update a data structure storing wager scenario data by collecting wager opportunity data from various sources (e.g., data feeds, player interactions) and populating the storage. In some embodiments, the data processing system can perform data cleaning or validation to maintain data accuracy, consistency, and completeness before storage. In some embodiments, the data processing system can associate additional relevant information (e.g., team logos, player statistics) with each wager opportunity. The data processing system can update existing wager opportunity records with additional information (e.g., odds changes, bet status) as it becomes available. In some embodiments, the data processing system can implement a data retention policy to determine the duration for which wager opportunity data is stored.

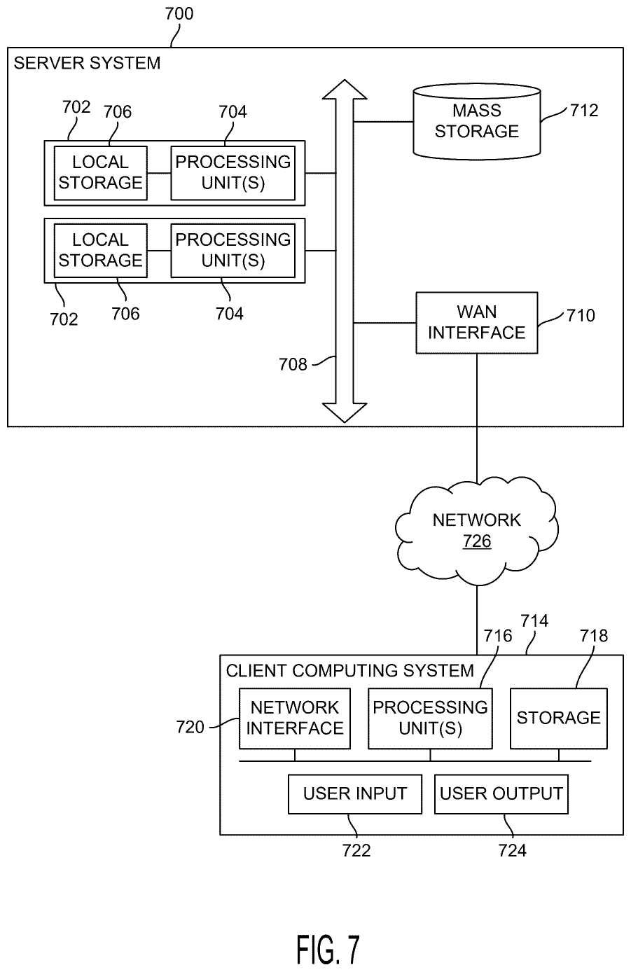

Various operations described herein may be implemented on computer systems. FIG. 7 shows a simplified block diagram of a server system 700, client computing system 714, and network 726 usable to implement certain embodiments of the present disclosure. In various embodiments, server system 700 or similar systems can implement services or servers described herein or portions thereof. Client computing system 714 or similar systems can implement clients described herein. The system (e.g., the data processing system 105) and others described herein may be similar to the server system 700.

Server system 700 can have a modular design that incorporates a number of modules 702; while two modules 702 are shown, any number may be provided. Each module 702 can include processing unit(s) 704 and local storage 706.

Processing unit(s) 704 can include a single processor, which can have one or more cores, or multiple processors. In some embodiments, processing unit(s) 704 can include a general-purpose primary processor as well as one or more special-purpose co-processors such as graphics processors, digital signal processors, or the like. In some embodiments, some or all processing unit(s) 704 may be implemented using customized circuits, such as application specific integrated circuits (ASICs) or field programmable gate arrays (FPGAs). In some embodiments, such integrated circuits execute instructions that are stored on the circuit itself. In other embodiments, processing unit(s) 704 can execute instructions stored in local storage 706. Any type of processors in any combination may be included in processing unit(s) 704.

Local storage 706 can include volatile storage media (e.g., DRAM, SRAM, SDRAM, or the like) and/or non-volatile storage media (e.g., magnetic or optical disk, flash memory, or the like). Storage media incorporated in local storage 706 may be fixed, removable or upgradeable as desired. Local storage 706 may be physically or logically divided into various subunits such as a system memory, a read-only memory (ROM), and a permanent storage device. The system memory may be a read-and-write memory device or a volatile read-and-write memory, such as dynamic random-access memory. The system memory can store some or all of the instructions and data that processing unit(s) 704 need at runtime. The ROM can store static data and instructions that are needed by processing unit(s) 704. The permanent storage device may be a non-volatile read-and-write memory device that can store instructions and data even when module 702 is powered down. The term “storage medium” as used herein includes any medium in which data may be stored indefinitely (subject to overwriting, electrical disturbance, power loss, or the like) and does not include carrier waves and transitory electronic signals propagating wirelessly or over wired connections.

In some embodiments, local storage 706 can store one or more software programs to be executed by processing unit(s) 704, such as an operating system and/or programs implementing various server functions such as functions of the data processing system 105 of FIG. 1 or any other system described herein, or any other server(s) associated with the data processing system 105, or any other system described herein.

“Software” refers generally to sequences of instructions that, when executed by set of processing unit(s) 704, cause the server system 700 (or portions thereof) to perform various operations, thus defining one or more specific machine embodiments that execute and perform the operations of the software programs. The instructions may be stored as firmware residing in read-only memory and/or program code stored in non-volatile storage media that may be read into volatile working memory for execution by processing unit(s) 704. Software may be implemented as a single program or a collection of separate programs or program modules that interact as desired. From local storage 706 (or non-local storage described below), processing unit(s) 704 can retrieve program instructions to execute and data to process in order to execute various operations described above.

In some embodiments, the server system 700, multiple modules 702 may be interconnected via a bus or other interconnect 708, forming a local area network that supports communication between modules 702 and other components of server system 700. Interconnect 708 may be implemented using various technologies including server racks, hubs, routers, etc.

A wide area network (WAN) interface 710 can provide data communication capability between the local area network (interconnect 708) and the network 726, such as the Internet. Technologies may be used, including wired (e.g., Ethernet, IEEE 802.3 standards) and/or wireless technologies (e.g., Wi-Fi, IEEE 802.11 standards).

In some embodiments, local storage 706 is intended to provide working memory for processing unit(s) 704, providing fast access to programs and/or data to be processed while reducing traffic on interconnect 708. Storage for larger quantities of data may be provided on the local area network by a set of mass storage subsystems 712 that may be connected to interconnect 708. The set of mass storage subsystems 712 may be based on magnetic, optical, semiconductor, or other data storage media, and may include one or more physical devices. Direct attached storage, storage area networks, network-attached storage, and the like may be used. Any data stores or other collections of data described herein as being produced, consumed, or maintained by a service or server may be stored in the set of mass storage subsystems 712. In some embodiments, additional data storage resources may be accessible via WAN interface 710 (potentially with increased latency).

Server system 700 can operate in response to requests received via WAN interface 710. For example, one of modules 702 can implement a supervisory function and assign discrete tasks to other modules 702 in response to received requests. Work allocation techniques may be used. As requests are processed, results may be returned to the requester via WAN interface 710. Such operation can generally be automated. Further, in some embodiments, WAN interface 710 can connect server systems to each other, providing scalable systems capable of managing high volumes of activity. Techniques for managing server systems and server farms (collections of server systems that cooperate) may be used, including dynamic resource allocation and reallocation.

Server system 700 can interact with various player-owned or player-operated devices via a wide-area network such as the Internet. An example of a player-operated device is shown in FIG. 7 as client computing system 714. Client computing system 714 may be implemented, for example, as a consumer device such as a smartphone, other mobile phone, tablet computer, wearable computing device (e.g., smart watch, eyeglasses), desktop computer, laptop computer, and so on.

For example, client computing system 714 can communicate via WAN interface 710. Client computing system 714 can include computer components such as a set of processors 716, storage device 718, network interface 720, user input device 722, and user output device 724. Client computing system 714 may be a computing device implemented in a variety of form factors, such as a desktop computer, laptop computer, tablet computer, smartphone, other mobile computing device, wearable computing device, or the like.

The set of processors 716 and storage device 718 may be similar to processing unit(s) 704 and local storage 706 described above. Suitable devices may be selected based on the demands to be placed on client computing system 714; for example, client computing system 714 may be implemented as a “thin” client with limited processing capability or as a high-powered computing device. Client computing system 714 may be provisioned with program code executable by the set of processors 716 to enable various interactions with server system 700 of a message management service such as accessing messages, performing actions on messages, and other interactions described above. In some embodiments, a client computing system can also interact with a messaging service independently of the message management service.

Network interface 720 can provide a connection to the network 726, such as a wide area network (e.g., the Internet) to which WAN interface 710 of server system 700 is also connected. In various embodiments, network interface 720 can include a wired interface (e.g., Ethernet) and/or a wireless interface implementing various RF data communication standards such as Wi-Fi, Bluetooth, or cellular data network standards (e.g., 3G, 4G, LTE, etc.).

User input device 722 can include any device (or devices) via which a user can provide signals to client computing system 714; client computing system 714 can interpret the signals as indicative of particular player requests or information. In various embodiments, user input device 722 can include any or all of a keyboard, touch pad, touch screen, mouse or other pointing device, scroll wheel, click wheel, dial, button, switch, keypad, microphone, and so on.

User output device 724 can include any device via which client computing system 714 can provide information to a user. For example, user output device 724 can include a display-to-display images generated by or delivered to client computing system 714. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). Some embodiments can include a device such as a touchscreen that function as both input and output device. In some embodiments, one or more other user output devices, such as the user output device 724, may be provided in addition to or instead of a display. Examples include indicator lights, speakers, tactile “display” devices, printers, and so on.

Some embodiments include electronic components, such as microprocessors, storage and memory that store computer program instructions in a computer readable storage medium. Many of the features described in this specification may be implemented as processes that are specified as a set of program instructions encoded on a computer readable storage medium. When these program instructions are executed by one or more processing units, they cause the processing unit(s) to perform various operation indicated in the program instructions. Examples of program instructions or computer code include machine code, such as is produced by a compiler, and files including higher-level code that are executed by a computer, an electronic component, or a microprocessor using an interpreter. Through suitable programming, the processing unit(s) 704 or the set of processors 716 can provide various functionality for server system 700 and client computing system 714, including any of the functionality described herein as being performed by a server or client, or other functionality associated with message management services.

It will be appreciated that server system 700 and client computing system 714 are illustrative and that variations and modifications are possible. Computer systems used in connection with embodiments of the present disclosure can have other capabilities not specifically described here. Further, while server system 700 and client computing system 714 are described with reference to particular blocks, it is to be understood that these blocks are defined for convenience of description and are not intended to imply a particular physical arrangement of component parts. For instance, different blocks may be but need not be located in the same facility, in the same server rack, or on the same motherboard. Further, the blocks need not correspond to physically distinct components. Blocks may be configured to perform various operations, e.g., by programming a processor or providing appropriate control circuitry, and various blocks might or might not be reconfigurable depending on how the initial configuration is obtained. Embodiments of the present disclosure may be realized in a variety of apparatus including electronic devices implemented using any combination of circuitry and software.

Embodiments of the subject matter and the operations described in this specification may be implemented in digital electronic circuitry, or in computer software embodied on a tangible medium, firmware, or hardware, including the structures disclosed in this specification and their structural equivalents, or in combinations of one or more of them. Embodiments of the subject matter described in this specification may be implemented as one or more computer programs, e.g., one or more components of computer program instructions, encoded on computer storage medium for execution by, or to control the operation of, data processing apparatus. The program instructions may be encoded on an artificially generated propagated signal, e.g., a machine-generated electrical, optical, or electromagnetic signal that is generated to encode information for transmission to suitable receiver apparatus for execution by a data processing apparatus. A computer storage medium may be, or be included in, a computer-readable storage device, a computer-readable storage substrate, a random or serial access memory array or device, or a combination of these. Moreover, while a computer storage medium is not a propagated signal, a computer storage medium can include a source or destination of computer program instructions encoded in an artificially generated propagated signal. The computer storage medium can also be, or be included in, one or more separate physical components or media (e.g., multiple CDs, disks, or other storage devices).

The operations described in this specification may be implemented as operations performed by a data processing apparatus on data stored on one or more computer-readable storage devices or received from other sources.

The terms “data processing apparatus,” “data processing system,” “client device,” “computing platform,” “computing device,” or “device” encompasses all kinds of apparatus, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of these. The apparatus and execution environment can realize various different computing model infrastructures, such as web services, distributed computing, and grid computing infrastructures.

A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform actions by operating on input data and generating output. The processes and logic flows can also be performed by, and apparatuses can also be implemented as, special purpose logic circuitry, e.g., an FPGA or an ASIC.

Processors suitable for the execution of a computer program include, by way of example, both general and special purpose microprocessors, and any one or more processors of any kind of digital computer. Generally, a processor will receive instructions and data from a read-only memory or a random-access memory or both. The elements of a computer include a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer may be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), for example. Devices suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a player, embodiments of the subject matter described in this specification may be implemented on a computer having a display device, e.g., a CRT (cathode ray tube), plasma, or LCD (liquid crystal display) monitor, for displaying information to the player and a keyboard and a pointing device, e.g., a mouse or a trackball, by which the player can provide input to the computer. Other kinds of devices may be used to provide for interaction with a player as well; for example, feedback provided to the player can include any form of sensory feedback, e.g., visual feedback, auditory feedback, or tactile feedback; and input from the player may be received in any form, including acoustic, speech, or tactile input. In addition, a computer can interact with a player by sending documents to and receiving documents from a device that is used by the player; for example, by sending web pages to a web browser on a player's client device in response to requests received from the web browser.

Embodiments of the subject matter described in this specification may be implemented in a computing system that includes a back-end component, e.g., as a data server, or that includes a middleware component, e.g., an application server, or that includes a front-end component, e.g., a client computer having a graphical user interface or a Web browser through which a player can interact with an implementation of the subject matter described in this specification, or any combination of one or more such back-end, middleware, or front-end components. The components of the system may be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as the system described herein can include clients and servers. For example, the system can include one or more servers in one or more data centers or server farms. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving input from a player interacting with the client device). Data generated at the client device (e.g., a result of an interaction, computation, or any other event or computation) may be received from the client device at the server, and vice-versa.

While this specification contains many specific implementation details, these should not be construed as limitations on the scope of any inventions or of what may be claimed, but rather as descriptions of features specific to particular embodiments of the systems and methods described herein. Certain features that are described in this specification in the context of separate embodiments can also be implemented in combination in a single implementation. Conversely, various features that are described in the context of a single implementation can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims may be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products. For example, the system could be a single module, a logic device having one or more processing modules, one or more servers, or part of a search engine.

Having now described some illustrative embodiments, it is apparent that the foregoing is illustrative and not limiting, having been presented by way of example. In particular, although many of the examples presented herein involve specific combinations of method acts or system elements, those acts, and those elements may be combined in other ways to accomplish the same objectives. Acts, elements and features discussed only in connection with one implementation are not intended to be excluded from a similar role in other embodiments.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate embodiments consisting of the items listed thereafter exclusively. In one implementation, the systems and methods described herein consist of one, each combination of more than one, or all of the described elements, acts, or components.

Any references to embodiments, elements, or acts of the systems and methods herein referred to in the singular may also embrace embodiments including a plurality of these elements; and any references in plural to any implementation, element, or act herein may also embrace embodiments including only a single element. References in the singular or plural form are not intended to limit the presently disclosed systems or methods, their components, acts, or elements to single or plural configurations. References to any act or element being based on any information, act or element may include embodiments where the act or element is based at least in part on any information, act, or element.

Any implementation disclosed herein may be combined with any other implementation, and references to “an implementation,” “some embodiments,” “an alternate implementation,” “various implementation,” “one implementation,” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and embodiments disclosed herein.

References to “or” may be construed as inclusive so that any terms described using “or” may indicate any of a single, more than one, and all of the described terms. Unless otherwise specified, terms combined with “or” are non-exclusive, such that the phrase “first item or second item” may refer to only the first item, only the second item, or both the first and second items.

Where technical features in the drawings, detailed description, or any claim are followed by reference signs, the reference signs have been included for the sole purpose of increasing the intelligibility of the drawings, detailed description, and claims. Accordingly, neither the reference signs nor their absence has any limiting effect on the scope of any claim elements.

The systems and methods described herein may be embodied in other specific forms without departing from the characteristics thereof. Although the examples provided may be useful for providing a system, the systems and methods described herein may be applied to other environments. The foregoing embodiments are illustrative, rather than limiting, of the described systems and methods. The scope of the systems and methods described herein may thus be indicated by the appended claims, rather than the foregoing description, and changes that come within the meaning and range of equivalency of the claims are embraced therein.

1. (canceled)

2. (canceled)

3. A method for responding to game parameter tolerances with a series of wager scenarios that exist within the game parameter tolerances, the method comprising:
maintaining an indexed data structure comprising a plurality of wager scenarios corresponding to a plurality of live events, wherein each scenario of the plurality of wager scenarios associated with a respective odds value of a respective wager scenario, wherein the indexed data structure is indexed by a set of indexes, and wherein the set of indexes comprise a first vector index and a second vector index;
receiving, from a client device, a prompt comprising an indication of a game parameter tolerance;
identifying a first ordered tolerance category from a series of tolerance categories based on the game parameter tolerance indicated in the prompt;
selecting a subset of the plurality of wager scenarios based on the indication of the game parameter tolerance determined from the prompt and the respective odds value of the plurality of wager scenarios retrieved via the indexed data structure;
selecting the subset of the plurality of wager scenarios that correspond to the first ordered tolerance category by:
selecting a first group of wager scenarios assigned to the first ordered tolerance category by searching through the first vector index based on the first ordered tolerance category; and
selecting a second group of wager scenarios assigned to a second ordered tolerance category that is adjacent to the first ordered tolerance category;
generating, using a language model, the subset of the plurality of wager scenarios, and the prompt, an output message identifying at least one of the subset of the plurality of wager scenarios to satisfy the game parameter tolerance of the prompt; and
providing the output message to the client device in response to the prompt.

4. A method for responding to game parameter tolerances with a series of wager scenarios that exist within the game parameter tolerances, the method comprising:
maintaining an indexed data structure comprising a plurality of wager scenarios corresponding to a plurality of live events, wherein each scenario of the plurality of wager scenarios associated with a respective odds value of a respective wager scenario;
receiving, from a client device, a prompt comprising an indication of a game parameter tolerance, wherein the client device is associated with a player profile;
selecting a subset of the plurality of wager scenarios based on the indication of the game parameter tolerance determined from the prompt and the respective odds value of the plurality of wager scenarios retrieved via the indexed data structure;
selecting the subset of the plurality of wager scenarios further based on odds values of historical wagers identified in the player profile by:
retrieving the historical wagers identified in the player profile from a player profile database; and
determining a set of game parameter tolerances based on the historical wagers, wherein generating an output message comprises providing the set of game parameter tolerances to a language model:
generating, using the language model, the subset of the plurality of wager scenarios, and the prompt, the output message identifying at least one of the subset of the plurality of wager scenarios to satisfy the game parameter tolerance of the prompt; and
providing the output message to the client device in response to the prompt.

5. A method for responding to game parameter tolerances with a series of wager scenarios that exist within the game parameter tolerances, the method comprising:
maintaining an indexed data structure comprising a plurality of wager scenarios corresponding to a plurality of live events, wherein each scenario of the plurality of wager scenarios associated with a respective odds value of a respective wager scenario;
receiving, from a client device, a prompt comprising an indication of a game parameter tolerance;
selecting a subset of the plurality of wager scenarios based on the indication of the game parameter tolerance determined from the prompt and the respective odds value of the plurality of wager scenarios retrieved via the indexed data structure;
generating, using a language model, the subset of the plurality of wager scenarios, and the prompt, an output message identifying at least one of the subset of the plurality of wager scenarios to satisfy the game parameter tolerance of the prompt;
providing the output message to the client device in response to the prompt;
selecting the subset of the plurality of wager scenarios based on a second output of the language model by:
providing the prompt to the language model to produce a second output, wherein at least a portion of the second output is used as a query; and
submitting a query to a database based on the second output.

6. The method of claim 3, further comprising:
determining a threshold odds value based on the game parameter tolerance indicated in the prompt; and
selecting a respective scenario for inclusion in the subset of the plurality of wager scenarios responsive to the respective odds value of the respective scenario satisfying the threshold odds value.

7. The method of claim 3, further comprising:
generating, for each respective scenario of the plurality of wager scenarios, a respective weight value based on a respective odds value of the respective scenario and one or more respective odds changes of the respective scenario; and
selecting the respective scenario for inclusion the subset of the plurality of wager scenarios based on the respective weight value.

8. The method of claim 3, wherein the client device is associated with a game parameter tolerance setting, further comprising:
determining that the game parameter tolerance indicated in the prompt exceeds a value of the game parameter tolerance setting; and
generating the output message to include a second indication that the game parameter tolerance indicated in the prompt exceeds the value of the game parameter tolerance setting.

9. The method of claim 3, further comprising:
determining the game parameter tolerance indicated in the prompt using a machine-learning model different from the language model.

10. (canceled)

11. (canceled)

12. A system, comprising:
one or more processors coupled to non-transitory memory, the one or more processors to:
maintain a data structure comprising a plurality of wager opportunities corresponding to a plurality of live events, each of the plurality of wager opportunities associated with a respective odds value;
receive, from a client device, a prompt comprising an indication of a risk tolerance;
determine a respective risk category of a plurality of risk categories for each of the plurality of wager opportunities;
identify a first risk category from the plurality of risk categories based on the risk tolerance indicated in the prompt;
select a subset of the plurality of wager opportunities based on the indication of the risk tolerance determined from the prompt and the respective odds value of the plurality of wager opportunities;
select the subset of the plurality of wager opportunities that correspond to the first risk category;
generate, using a language model, the subset, and the prompt, an output message identifying at least one of the subset of the plurality of wager opportunities to satisfy the risk tolerance of the prompt; and
provide the output message to the client device in response to the prompt.

13. A system, comprising:
one or more processors coupled to non-transitory memory, the one or more processors to:
maintain a data structure comprising a plurality of wager opportunities corresponding to a plurality of live events, each of the plurality of wager opportunities associated with a respective odds value;
receive, from a client device, a prompt comprising an indication of a risk tolerance, wherein the client device is associated with a player profile;
select a subset of the plurality of wager opportunities based on the indication of the risk tolerance determined from the prompt and the respective odds value of the plurality of wager opportunities;
select the subset of the plurality of wager opportunities further based on odds values of one or more historical wagers identified in the player profile;
generate, using a language model, the subset, and the prompt, an output message identifying at least one of the subset of the plurality of wager opportunities to satisfy the risk tolerance of the prompt; and
provide the output message to the client device in response to the prompt.

14. A system, comprising:
one or more processors coupled to non-transitory memory, the one or more processors to:
maintain a data structure comprising a plurality of wager opportunities corresponding to a plurality of live events, each of the plurality of wager opportunities associated with a respective odds value;
receive, from a client device, a prompt comprising an indication of a risk tolerance;
select a subset of the plurality of wager opportunities based on the indication of the risk tolerance determined from the prompt and the respective odds value of the plurality of wager opportunities;
select the subset of the plurality of wager opportunities based on an output of a language model;
generate, using the language model, the subset, and the prompt, an output message identifying at least one of the subset of the plurality of wager opportunities to satisfy the risk tolerance of the prompt; and
provide the output message to the client device in response to the prompt.

15. The system of claim 12, wherein the one or more processors are further configured to:
determine a threshold odds value based on the risk tolerance indicated in the prompt; and
select each wager opportunity for inclusion in the subset responsive to the respective odds value of the wager opportunity satisfying the threshold odds value.

16. The system of claim 12, wherein the one or more processors are further configured to:
generate, for each wager opportunity of the plurality of wager opportunities, a respective weight value based on the respective odds value and one or more respective odds changes of the wager opportunity; and
select the subset of the plurality of wager opportunities based on the weight value.

17. The system of claim 12, wherein the client device is associated with a risk tolerance setting, and wherein the one or more processors are further configured to:
determine, using the one or more processors, that the risk tolerance indicated in the prompt exceeds a value of the risk tolerance setting; and
generate the output message to include a second indication that the risk tolerance indicated in the prompt exceeds the value of the risk tolerance setting.

18. The system of claim 12, wherein the plurality of wager opportunities comprises at least one of a single wager, a parlay wager, a same-game parlay (SGP) wager, or an exotic wager.

19. The system of claim 12, wherein the one or more processors are further configured to:
determine the risk tolerance indicated in the prompt using a machine-learning model different from the language model.

20. (canceled)

21. The method of claim 3, wherein the client device is associated with a player profile, further comprising selecting the subset of the plurality of wager scenarios further based on odds values of historical wagers identified in the player profile by:
retrieving the historical wagers identified in the player profile from a player profile database; and
determining a set of game parameter tolerances based on the historical wagers, wherein generating the output message comprises providing the set of game parameter tolerances to the language model.

22. The method of claim 3, further comprising selecting the subset of the plurality of wager scenarios based on a second output of the language model by:
providing the prompt to the language model to produce a second output, wherein at least a portion of the second output is used as a query; and
submitting a query to a database based on the second output.

23. The system of claim 12, wherein the client device is associated with a player profile, and wherein the one or more processors are further configured to:
select the subset of the plurality of wager opportunities further based on odds values of one or more historical wagers identified in the player profile.

24. The system of claim 12, wherein the one or more processors are further configured to:
select the subset of the plurality of wager opportunities based on an output of the language model.

25. A system for responding to game parameter tolerances provided in player-provided prompts with a series of wager scenarios that exist within the game parameter tolerances, the system comprising:
one or more processors coupled to non-transitory memory, the one or more processors to:
maintain an indexed data structure comprising a plurality of wager scenarios corresponding to a plurality of live events, wherein each scenario of the plurality of wager scenarios associated with a respective odds value of a respective wager scenario, wherein the indexed data structure is indexed by a set of indexes, and wherein the set of indexes comprise a first vector index and a second vector index;
receive, from a client device, a prompt comprising an indication of a game parameter tolerance;
identify a first ordered tolerance category from a series of tolerance categories based on the game parameter tolerance indicated in the prompt;
select a subset of the plurality of wager scenarios based on the indication of the game parameter tolerance determined from the prompt and the respective odds value of the plurality of wager scenarios retrieved via indexes of the indexed data structure;
select the subset of the plurality of wager scenarios that correspond to the first ordered tolerance category by:
selecting a first group of wager scenarios assigned to the first ordered tolerance category by searching through the first vector index based on the first ordered tolerance category; and
selecting a second group of wager scenarios assigned to a second ordered tolerance category that is adjacent to the first ordered tolerance category;
generate, using a language model, the subset, and the prompt, an output message identifying at least one of the subset of the plurality of wager scenarios to satisfy the game parameter tolerance of the prompt; and
provide the output message to the client device in response to the prompt.

26. A system for responding to game parameter tolerances provided in player-provided prompts with a series of wager scenarios that exist within the game parameter tolerances, the system comprising:
one or more processors coupled to non-transitory memory, the one or more processors to:
maintain an indexed data structure comprising a plurality of wager scenarios corresponding to a plurality of live events, wherein each scenario of the plurality of wager scenarios associated with a respective odds value of a respective wager scenario;
receive, from a client device, a prompt comprising an indication of a game parameter tolerance, wherein the client device is associated with a player profile;
select a subset of the plurality of wager scenarios based on the indication of the game parameter tolerance determined from the prompt and the respective odds value of the plurality of wager scenarios retrieved via indexes of the indexed data structure;
select the subset of the plurality of wager scenarios further based on odds values of historical wagers identified in the player profile by:
retrieving the historical wagers identified in the player profile from a player profile database; and
determining a set of game parameter tolerances based on the historical wagers, wherein generating an output message comprises providing the set of game parameter tolerances to a language model;
generate, using the language model, the subset, and the prompt, the output message identifying at least one of the subset of the plurality of wager scenarios to satisfy the game parameter tolerance of the prompt; and
provide the output message to the client device in response to the prompt.

27. A system for responding to game parameter tolerances provided in player-provided prompts with a series of wager scenarios that exist within the game parameter tolerances, the system comprising:
one or more processors coupled to non-transitory memory, the one or more processors to:
maintain an indexed data structure comprising a plurality of wager scenarios corresponding to a plurality of live events, wherein each scenario of the plurality of wager scenarios associated with a respective odds value of a respective wager scenario;
receive, from a client device, a prompt comprising an indication of a game parameter tolerance;
select a subset of the plurality of wager scenarios based on the indication of the game parameter tolerance determined from the prompt and the respective odds value of the plurality of wager scenarios retrieved via indexes of the indexed data structure;
generate, using a language model, the subset, and the prompt, an output message identifying at least one of the subset of the plurality of wager scenarios to satisfy the game parameter tolerance of the prompt;
provide the output message to the client device in response to the prompt; and
select the subset of the plurality of wager scenarios based on a second output of the language model by:
providing the prompt to the language model to produce a second output, wherein at least a portion of the second output is used as a query; and
submitting a query to a database based on the second output.

28. A method, comprising:
maintaining a data structure comprising a plurality of wager opportunities corresponding to a plurality of live events, each of the plurality of wager opportunities associated with a respective odds value;
receiving, from a client device, a prompt comprising an indication of a risk tolerance;
determining a respective risk category of a plurality of risk categories for each of the plurality of wager opportunities;
identifying a first risk category from the plurality of risk categories based on the risk tolerance indicated in the prompt;
selecting a subset of the plurality of wager opportunities based on the indication of the risk tolerance determined from the prompt and the respective odds value of the plurality of wager opportunities;
selecting the subset of the plurality of wager opportunities that correspond to the first risk category;
generating, using a language model, the subset, and the prompt, an output message identifying at least one of the subset of the plurality of wager opportunities to satisfy the risk tolerance of the prompt; and
providing the output message to the client device in response to the prompt.

29. A method, comprising:
maintaining a data structure comprising a plurality of wager opportunities corresponding to a plurality of live events, each of the plurality of wager opportunities associated with a respective odds value;
receiving, from a client device, a prompt comprising an indication of a risk tolerance, wherein the client device is associated with a player profile;
selecting a subset of the plurality of wager opportunities based on the indication of the risk tolerance determined from the prompt and the respective odds value of the plurality of wager opportunities;
selecting the subset of the plurality of wager opportunities further based on odds values of one or more historical wagers identified in the player profile;
generating, using a language model, the subset, and the prompt, an output message identifying at least one of the subset of the plurality of wager opportunities to satisfy the risk tolerance of the prompt; and
providing the output message to the client device in response to the prompt.

30. A method, comprising:
maintaining a data structure comprising a plurality of wager opportunities corresponding to a plurality of live events, each of the plurality of wager opportunities associated with a respective odds value;
receiving, from a client device, a prompt comprising an indication of a risk tolerance;
selecting a subset of the plurality of wager opportunities based on the indication of the risk tolerance determined from the prompt and the respective odds value of the plurality of wager opportunities;
selecting the subset of the plurality of wager opportunities based on an output of a language model;
generating, using a language model, the subset, and the prompt, an output message identifying at least one of the subset of the plurality of wager opportunities to satisfy the risk tolerance of the prompt; and
providing the output message to the client device in response to the prompt.
